(19) United States
(12) Patent Application Publication
(10) Pub. No.: US 2014/0335950 A1
(43) Pub. Date: Nov. 13, 2014

(54) IMAGE DISPLAY DEVICE AND IMAGE DISPLAY METHOD

(71) Applicant: SONY CORPORATION, Tokyo (JP)

(72) Inventors: Yuki Sugiue, Tokyo (JP); Tatsuya Yamazaki, Kanagawa (JP); Shinya Tatsumi, Tokyo (JP)

(73) Assignee: SONY CORPORATION, Tokyo (JP)

(21) Appl. No.: 14/263,026

(22) Filed: Apr. 28, 2014

(30) Foreign Application Priority Data
May 10, 2013 (JP) 2013-100738

(51) Int. Cl. A63F 13/00

(52) U.S. Cl. CPC A63F 13/00
USPC 463/31

(57) ABSTRACT

An image display device may include a control device to estimate a user state based on a detected electroencephalogram signal of a user who is playing a game, and to control display of an image to the user for providing training for the game based on the user state.

### CROSS REFERENCE TO RELATED APPLICATIONS

This application claims the benefit of Japanese Priority Patent Application JP 2013-100738 filed May 10, 2013, the entire contents of which are incorporated herein by reference.

### BACKGROUND

The present technology relates to an image display device which displays a game image, and an image display method thereof, and in particular, to an image display device which displays a game image, and performs training for a game, and an image display method thereof.

At present, video games, or computer games are widespread. In video games for general consumers, game software (computer program for game), and a main body of a game machine for executing the game software are used. In former times, a game in progress has been displayed on a display which is connected to a main body of a game machine such as a television receiver, however, a mobile game machine integrated with a display has been widely used. In addition, it is also possible to use a “head mounted display” which is mounted on a head or a face of a user when displaying a game.

For example, in a head mounted display on which a game image is projected, a game scene being changed by detecting a direction of a user's face using an inclination sensor has been proposed (for example, refer to Japanese Unexamined Patent Application Publication No. 2001-29659). In addition, a head mounted display in which an image and a signal are received from a computer which controls a game, and which makes a user experience a game excellent in a sense of realism by experiencing a vibration, by driving a vibrating motor has been proposed (for example, refer to Japanese Unexamined Patent Application Publication No. 2003-125313).

Genres of the game software include many different things such as a Role Playing Game (RPG), action, puzzles, races, sports, fights, adventures, simulations, music, or the like. For example, in a fighting game, martial arts are made into a game, in which a character which is operated by a player fights with an opponent character in a form of martial arts. In addition, in a music game, performing of music is made into a game, in which a game is progressed when a player performs an operation such as playing a musical instrument according to a rhythm or music.

In addition, in a competition-type game such as a fighting game, a world tournament offering prize money is opened, there is a professional club, or a supporter thereof, and further, there is a case in which a game which is sponsored is broadcasted on television, and accordingly, the game resembles sports in a real world. A professional gamer who earns a prize of much money, or signs a sponsor is also called an athlete gamer, or a cyber athlete. Since there is an economic incentive such as prize money, or a sponsor fee, there is motivation to win, and for the athlete gamer to be strong, similarly to sports athletes. In addition, in such a game, physical strength, and endurance are necessary when playing for a long time.

In real world sports, there is sufficient training equipment such as machines for weight training, and a training method is established. Accordingly, each player can work hard at training using training equipment, or a training method toward a goal such as a desire to win, or to be strong.

On the other hand, there is no training method for a video game in a virtual world. For this reason, a gamer should make progress by repeatedly performing a video game, earnestly, or divert to general training in real world sports. However, such a training method takes time when using, is not simple or easy, and is painful when continuing, since the method is generally simple and boring. A player should perform such a training method manually based on subjectivity, and it takes time. In addition, since it is difficult to objectively show a training result, a personalized adjustment is insufficient. In other words, it is considered that a training effect itself is unreliable.

### SUMMARY

It is desirable to provide an excellent image display device which displays a game image, and can preferably perform training for a game, and an image display method thereof.

According to an embodiment of the present disclosure, an information processing apparatus may include a control device to determine a plurality of candidate texts to correct a target text which is from an input text string, based on preceding text located at a position preceding the target text and succeeding text located at a position succeeding the target text.

According to an embodiment of the present disclosure, an image display method may include estimating, by a control device, a user state based on a detected electroencephalogram signal of a user who is playing a game, and controlling, by the control device, display of an image to the user for providing training for the game based on the user state.

According to an embodiment of the present disclosure, a non-transitory recording medium may be recorded with a program executable by a computer. The program may include estimating a user state based on a detected electroencephalogram signal of a user who is playing a game, and controlling display of an image to the user for providing training for the game based on the user state.

According to an embodiment of the present disclosure, an information processing apparatus may include a control device to: estimate a user state based on a detected electroencephalogram signal of a user who is playing a game, in which the detected electroencephalogram signal is provided from an external device over a communication network, and control providing, over the communication network, of a display signal to control display of an image to the user for providing training for the game based on the user state.

According to an embodiment of the present technology, there is provided an image display device which includes an electroencephalogram detecting unit which detects electroencephalograms of a user, and an image control unit which controls a game image which is presented to the user based on a detection result of the electroencephalogram.

In the device according to the embodiment, the image control unit may control the game image which is presented to the user based on a result in which any one of a state of mind, a mental condition, and a physical condition of the user is estimated on the basis of the electroencephalogram.

In the device according to the embodiment, the image control unit may display an image for performing training for a game by the user, by limiting or processing a part, or the whole of the original game image.

In the device according to the embodiment, the image control unit may perform the training for the game for improving a ZONE level according to a ZONE level of the user which is estimated from the electroencephalogram.

In the device according to the embodiment, the image control unit may present a first training image which improves concentration of the user in order to make the user reach the ZONE level when the user lacks concentration.

In the device according to the embodiment, the image control unit may present a second training image for relaxation of the user when the user is nervous, in order to make the user reach the ZONE level.

In the device according to the embodiment, the image control unit may present to the user a ZONE level which is estimated based on a detection result of the electroencephalogram.

In the device according to the embodiment, the image control unit may display an indicator which denotes the ZONE level using a length at least on one end of left and right and top and bottom of the game image.

In the device according to the embodiment, the image control unit may change a display color of the indicator according to changes in the concentration and relaxation of the user which are estimated from the electroencephalogram.

In the device according to the embodiment, the image control unit may display the game image by replacing the image with a training image which improves the ZONE level according to a decrease in the ZONE level of the user.

In the device according to the embodiment, the image control unit may display the game image only in one eye of the user according to familiarity of the user which is estimated from the electroencephalogram.

In the device according to the embodiment, the image control unit may display the game image only in one eye of left and right eyes of the user, and display the game image only in the other eye when the familiarity of the user is improved.

In the device according to the embodiment, the image control unit may display information which induces a line of sight of the user in the game image according to the concentration of the user which is estimated from the electroencephalogram.

In the device according to the embodiment, the image control unit may display a region which limits a field of view, or shields the field of view, except for a portion to which attention is paid in the game image.

In the device according to the embodiment, the image control unit may display a field of vision guide for causing eye contact with the portion to which attention is paid in the game image.

In the device according to the embodiment, the image control unit may change a display form of the field of vision guide according to a change in the concentration of the user.

In the device according to the embodiment, the image control unit may limit the field of vision of the user in time by blocking the game image at every fixed interval according to the familiarity of the user which is estimated from the electroencephalogram.

In the device according to the embodiment, the image control unit may set the interval of blocking the game image to be long when the familiarity of the user is increased.

In the device according to the embodiment, the image control unit may display any one of a black image, an image in which the original game image is blurred, an image in which a part of the original game image is shielded, and an image in which a display of the original game image is temporarily stopped, in a period of time in which the game image is shielded.

According to another embodiment, there is provided an image display method which includes detecting an electroencephalogram of a user, and controlling a game image which is presented to the user based on a detection result of the electroencephalogram.

According to the technology which is disclosed in the specification, it is possible to provide an excellent image display device which displays a game image, and can preferably perform training for a game, and an image display method thereof.

The image display device to which the technology disclosed in the specification is applied can cause effects in which a sufficient adjustment catering to an individual user is performed, for example, objective training is executed by limiting or processing a display image at a time of executing a game based on a user state, as training for a game, when an electroencephalogram of a user is detected, and the user state is estimated based on the electroencephalogram.

In addition, effects which are described in the specification are merely examples, and effects of the present technology are not limited to these. In addition, there also is a case in which the present technology causes additional effects in addition to the above described effects.

Other further objects, characteristics, or advantages of the technology which are disclosed in the specification will be clarified by detailed descriptions based on embodiments which will be described later, or accompanying drawings.

### BRIEF DESCRIPTION OF THE DRAWINGS

FIG. 1A is a diagram which schematically illustrates a basic configuration of an image display device to which the technology which is disclosed in the specification is applied;

FIG. 1B is a diagram which illustrates an internal configuration example of an electroencephalogram detecting unit;

FIG. 1C is a diagram which illustrates an internal configuration example of an image control unit;

FIG. 2A is a diagram which exemplifies a specific configuration method of the image display device;

FIG. 2B is a diagram which exemplifies a specific configuration method of the image display device;

FIG. 2C is a diagram which exemplifies a specific configuration method of the image display device;

FIG. 2D is a diagram which exemplifies a specific configuration method of the image display device;

FIG. 2E is a diagram which exemplifies a specific configuration method of the image display device;

FIG. 3 is a diagram in which a level of a performance of a person is viewed in the long term;

FIG. 4 is a diagram in which a level of a performance of a person is viewed in the short term;

FIG. 5 is a diagram in which a level of a performance of a person is viewed synthetically;

FIG. 6 is a diagram in which an improvement of a long term “Base” component of a performance is exemplified;

FIG. 7 is a diagram in which an improvement of a long term “Base” component of a performance is exemplified;

FIG. 8 is a diagram in which an improvement of a short term “Condition” component of a performance is exemplified;

FIG. 9 is a diagram in which a training method which is proposed in the specification is put together;

FIG. 10 is a diagram which illustrates an example of a first training image for enhancing concentration;

FIG. 11 is a diagram which illustrates an example of a second training image for relaxation;

FIG. 12 is a flowchart which illustrates processing order which is performed by an image control unit in order to execute training using a Zone Starter;

FIG. 13 is a diagram which illustrates a configuration example of a display image when performing neurofeedback training;

FIG. 14 is a diagram which illustrates a configuration example of a screen on which training of a Base component of a performance is performed;

FIG. 15 is a flowchart which illustrates processing order which is performed by the image control unit in order to execute the neurofeedback training;

FIGS. 16A to 16C are diagrams which illustrate display examples of an image when performing one eye warm-up;

FIG. 17 is a diagram which illustrates a transition of familiarity of a user when executing the one eye warm-up;

FIG. 18 is a flowchart which illustrates processing order which is performed by the image control unit in order to execute the one eye warm-up;

FIG. 19 is a flowchart which illustrates detailed processing order of the one eye warm-up;

FIG. 20 is a diagram which illustrates a display example of a field of vision guide in an image of a fighting game;

FIG. 21 is a diagram which illustrates a display example of a field of vision guide in an image of the fighting game;

FIG. 22 is a diagram which illustrates a display example of a field of vision guide in an image of the fighting game;

FIG. 23 is a diagram which illustrates a display example of a field of vision guide in an image of a music game;

FIG. 24 is a flowchart which illustrates processing order which is performed by the image control unit in order to execute the field of vision guide;

FIGS. 25A to 25E are diagrams which illustrate display examples of images when performing stroboscopic training;

FIG. 26 is a diagram which illustrates a transition of familiarity of a user when executing the stroboscopic training;

FIG. 27 is a diagram which exemplifies an image in which a game image is made into a watermark image;

FIG. 28 is a diagram which exemplifies an image in which a game image is made into a blurry image;

FIG. 29 is a diagram which exemplifies an image in which a game image is partially shielded in a field of vision shielding region;

FIG. 30 is a flowchart which illustrates processing order which is performed by the image control unit in order to execute stroboscopic training; and

FIG. 31 is a flowchart which illustrates detailed processing order of the stroboscopic training.

### DETAILED DESCRIPTION OF EMBODIMENTS

Hereinafter, embodiments of the technology which is disclosed in the specification will be described in detail with reference to drawings.

The technology which is disclosed in the specification can be applied to an image display device which displays a game image. The image display device may be a main body of a game machine, however, the device has main characteristics of including a function of detecting an electroencephalogram of a user (game player), and performing training for a game. That is, the image display device executes objective training for the game by limiting or processing a display image at a time of executing a game based on a user state, when the user state such as a state of mind, a mental condition, and a physical condition are estimated on the basis of a detected electroencephalogram. The user is able to perform a sufficient adjustment corresponding the user himself through the training for the game based on a state of the user himself.

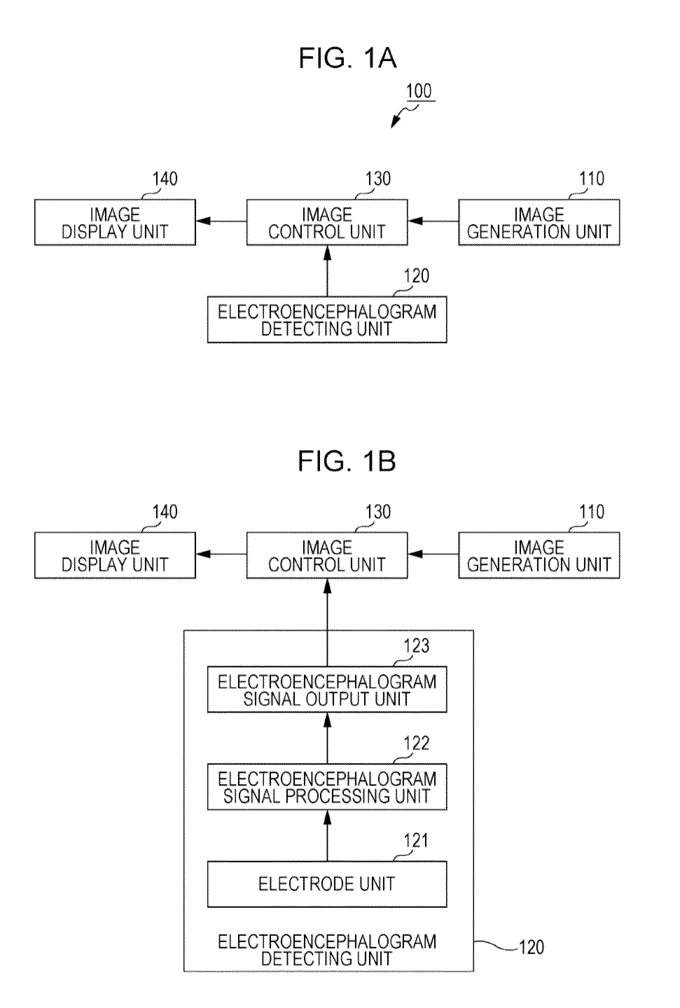

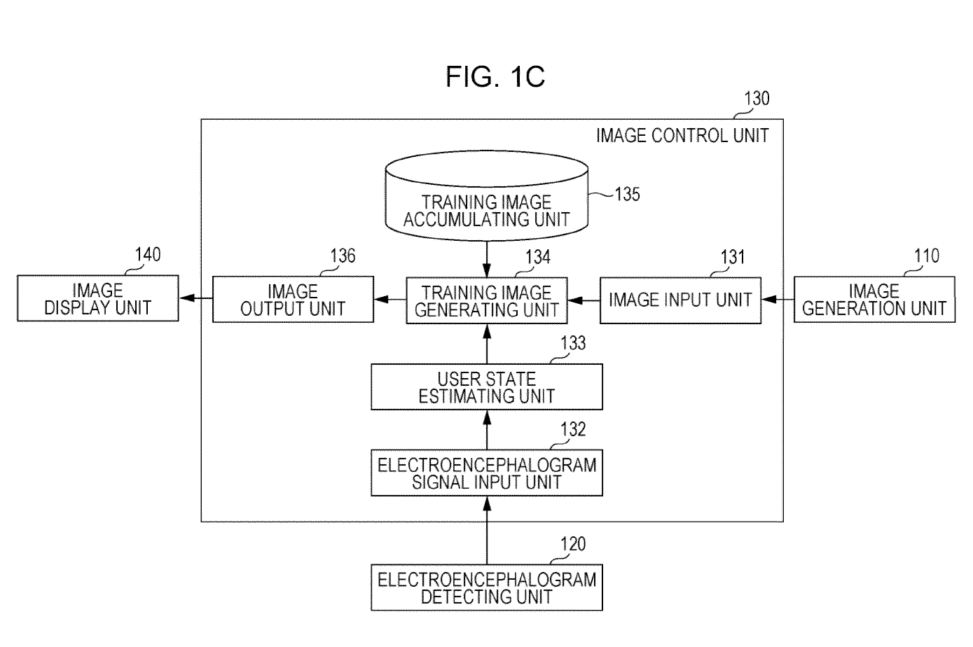

FIG. 1A schematically illustrates a basic configuration of an image display device 100 to which the technology which is disclosed in the specification is applied. The image display device 100 includes an image generation unit 110, an electroencephalogram detecting unit 120, an image control unit 130, and an image display unit 140.

The image generation unit 110 generates a source image such as an image of a game in the middle of executing, according to a user operation, or the like, through an input unit which is not shown, and outputs the image to the image control unit 130.

The electroencephalogram detecting unit 120 detects an electroencephalogram (EEG) of a user who is playing a game, and outputs a detected electroencephalogram signal to the image control unit 130.

FIG. 1B illustrates an internal configuration example of the electroencephalogram detecting unit 120. The illustrated electroencephalogram detecting unit 120 includes an electrode unit 121, an electroencephalogram signal processing unit 122, and an electroencephalogram signal output unit 123. The electrode unit 121 is configured of two electrodes (dipole) which are arranged on a scalp of a user, for example, and the electroencephalogram signal processing unit 122 extracts an electroencephalogram signal based on a fluctuation in a potential difference between electrodes. The electroencephalogram signal output unit 123 sends out an electroencephalogram signal in a wired or wireless manner. When transmitting the electroencephalogram signal, it is possible to use, for example, a Bluetooth (registered trademark) Low Energy (BLE) communication, an ultra-low power consumption wireless communication such as ANT, a human body communication, a signal transmission through conductive fiber, or the like.

The image control unit 130 performs processing of a display image when executing a game. In addition, the image display unit 140 displays the display image when executing a game which is output from the image control unit 130, or a training image for a game which is generated in the image control unit 130, and outputs the image.

When performing training for a game, the image control unit 130 generates an image which is used in the training by limiting or processing a display image at a time of executing a game, based on a user state, when an electroencephalogram signal which is input from the electroencephalogram detecting unit 120 is analyzed, and the user state is estimated.

FIG. 1C illustrates an internal configuration example of the image control unit 130. The illustrated image control unit 130 includes an image input unit 131, an electroencephalogram signal input unit 132, a user state estimating unit 133, a training image generating unit 134, a training image accumulating unit 135, and an image output unit 136.

The image input unit 131 inputs a source image such as an image of a game in the middle of executing from the image generation unit 110. The electroencephalogram signal input unit 132 communicates with the electroencephalogram signal output unit 123 on the electroencephalogram detecting unit 120 side, and inputs an electroencephalogram signal which is detected from the scalp of a user. The user state estimating unit 133 estimates a current state of mind, a mental condition, and a physical condition of a user by analyzing the input electroencephalogram signal.

The training image generating unit 134 generates an image for performing training for a game by limiting or processing a display of a part of regions of a game image which is input through the image input unit 131 based on a user state which is estimated by the user state estimating unit 133. In addition, the training image generating unit 134 may generate the image for performing training for a game by replacing a part, or the whole region of the game image as the source image with an image which is read out from the training image accumulating unit 135, or by processing the original game image using an image which is output from the training image accumulating unit 135. In addition, the image for executing the training for a game (only when training for a game is executed) which is generated in the training image generating unit 134, or the source image (only when training for a game is not executed) which is input from the image input unit 131 is output to the image display unit 140 from the image output unit 136.

It is possible to execute objective training since the image which is displayed when performing the training for a game is based on a user state, and it is possible for a user to play a game after being subject to a sufficient adjustment which is catering to an individual. Details of an image which is displayed when performing training for a game will be described later.

The image display device 100 executes the training for a game ahead of a start of a game by a user, however, when detecting that a performance of the user is lowered at the time of playing the game, the training for a game (that is, processing of training image generating unit 134) is automatically started. Alternatively, the image display device 100 may start the training for a game using a manual operation by a user at an arbitrary timing.

In addition, the electroencephalogram detecting unit 120 continuously outputs an electroencephalogram signal to the image control unit 130 by being in a constant operating state, basically. However, the electroencephalogram detecting unit 120 may be intermittently operated at a predetermined time interval. Alternatively, the electroencephalogram detecting unit 120 may be automatically started when a predetermined event occurs in the middle of executing the game, by setting the electroencephalogram detecting unit 120 to a stopped state, basically. In addition, the electroencephalogram detecting unit 120 may be stopped by operating a manual switch (not shown) when the training for a game is not necessary for the user.

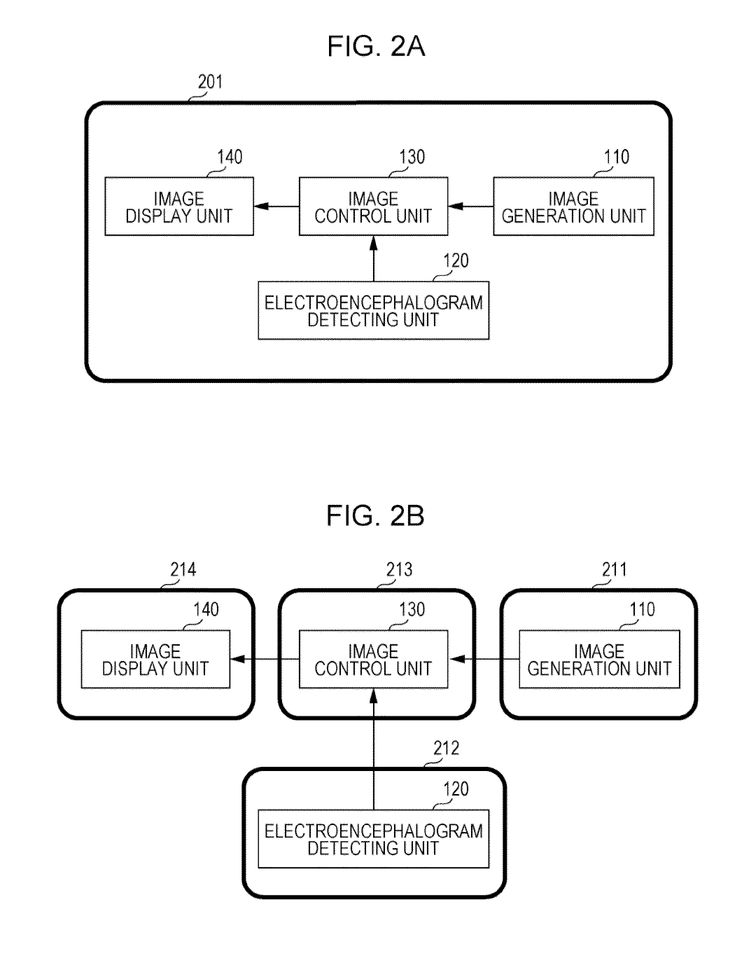

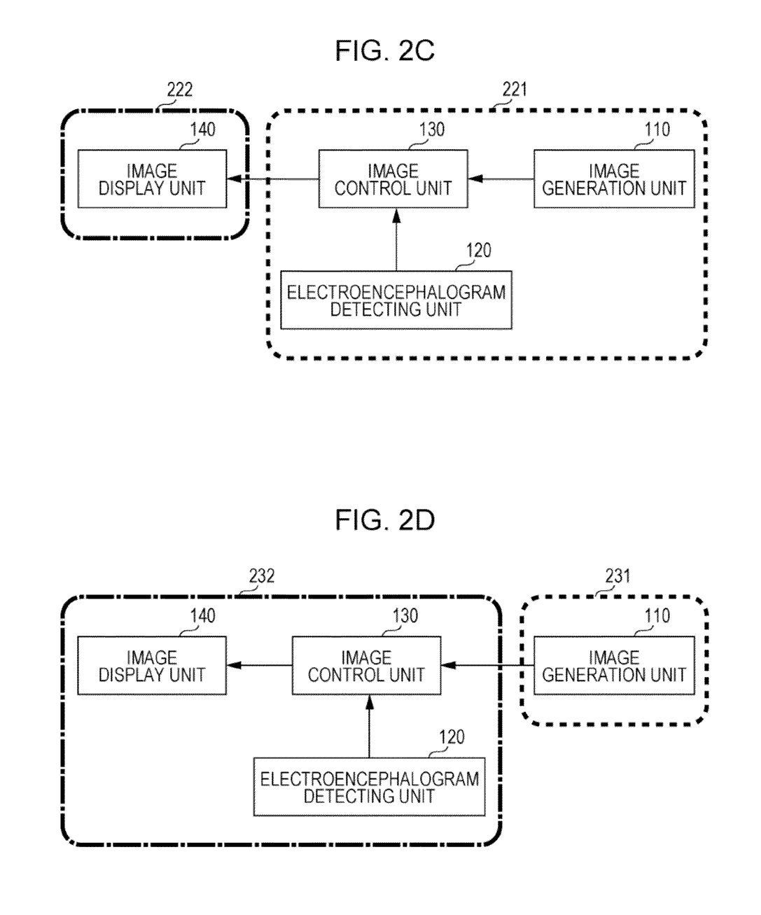

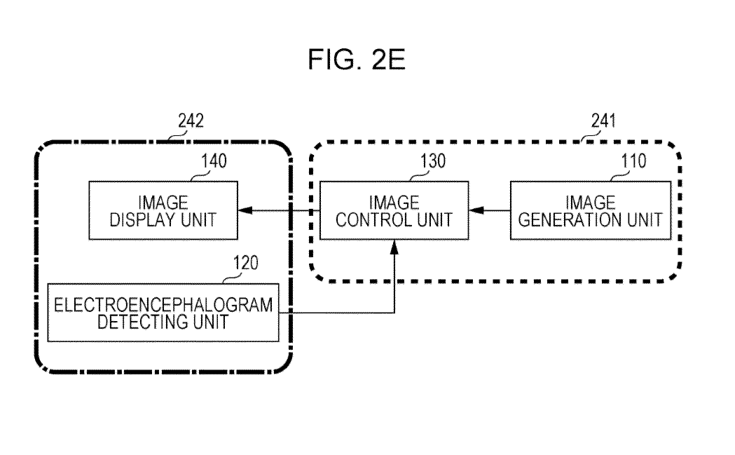

FIGS. 2A to 2E exemplify specific configuration methods of the image display device 100. In the example which is illustrated in FIG. 2A, all of components of the image generation unit 110, the electroencephalogram detecting unit 120, the image control unit 130, and the image display unit 140 are mounted on a single device, as are surrounded with a thick line 201. In addition, in contrast to this, in the example which is illustrated in FIG. 2B, the image generation unit 110, the electroencephalogram detecting unit 120, the image control unit 130, and the image display unit 140 are configured as physically independent devices 211, 212, 213, and 214 which are respectively surrounded with a thick line.

In the example which is illustrated in FIG. 2C, one device 221 such as a main body of a game machine, or the like, is configured of the image generation unit 110, the electroencephalogram detecting unit 120, and the image control unit 130, and the other device 222 is configured of the image display unit 140, as are surrounded with a dashed line, and a dotted-dashed line, respectively.

In the example which is illustrated in FIG. 2D, one device 231 such as a main body of a game machine, or the like, is configured of the image generation unit 110, and the other device 232 is configured of the electroencephalogram detecting unit 120, the image control unit 130, and the image display unit 140, as are surrounded with a dashed line, and a dotted-dashed line, respectively.

In the example which is illustrated in FIG. 2E, one device 241 such as a main body of a game machine, or the like, is configured of the image generation unit 110, and the image control unit 130, and the other device 242 is configured of the electroencephalogram detecting unit 120, and the image display unit 140, as are surrounded with a dashed line, and a dotted-dashed line, respectively.

In one embodiment, one or more of the components included in the image display device 100 described above may be provided to a communication device capable of communicating with the image display device 100, such as a server device or a so-called cloud server. Moreover, instead of being stored in the image display device 100, a computer program for causing components that may be included in the image display device 100 described above to exert functions equivalent to those in the components may be stored in the communication device, such as a server device or cloud server.

In any one of the examples which are illustrated in FIGS. 2A to 2E, it is also possible to configure a device including the image display unit 140 as a device which is used by being mounted on a head or a face of a user, which is called a head mounted display (for example, refer to Japanese Unexamined Patent Application Publication No. 2012-141461), for example. According to such a device, it is possible to easily provide the electrode unit 121 which detects a fluctuation in a potential difference from the scalp of a user. As a matter of course, the device which includes the image display unit 140 may be a common planar display, not the head mounted display.

In addition, in order to realize a part of embodiments (which will be described later) of the technology which is disclosed in the specification, it is preferable that the image display unit 140 display an image individually with respect to a left eye and a right eye of a user. For example, the device including the image display unit 140 may be a both eyes-type head mounted display (for example, refer to Japanese Unexamined Patent Application Publication No. 2012-141461).

Alternatively, when the device including the image display unit 140 is a planar display, the device may be a display which can display a left eye image and a right eye image by performing time division multiplexing, or spatial multiplexing with respect to the left eye image and the right eye image (for example, refer to Japanese Unexamined Patent Application Publication No. 2012-198364). There is a type in which the left eye image and the right eye image can be separated on the user side even in a case of naked eyes, and a type in which the left eye image and the right eye image are separated using divided spectacles (shutter glasses, polarized glasses, or the like). In a case of the latter, the electrode unit 121 which detects a fluctuation in the potential difference from the scalp of a user may be provided in the divided spectacles.

An electroencephalogram signal is classified into basic patterns such as an α wave (8 to 13 Hz), a β wave (equal to or greater than 14 Hz), a γ wave (1 to 3 Hz), and a θ wave (4 to 7 Hz) according to a frequency band. The basic pattern is changed depending on an awakening degree, a physical condition, age, other conditions, or the like, of a person whose electroencephalogram is detected. In general, it is known that the α wave appears on the head posterior when a person is less mentally active, and can be suppressed, or attenuated with care or a mental effort, or the θ wave appears on the occipital lobe when being in somnolence. In practice, it is possible to estimate conditions such as a mental state of a person more accurately, by dividing one basic pattern such as the α wave into more finely split frequency bands, and analyzing the basic pattern, or by complexly analyzing a detection result of a plurality of basic patters. For example, a method in which a state of mind such as a degree of concentration, relaxation, or a ZONE of a person is detected by analyzing an electroencephalogram signal has also been reported (for example, refer to “Evaluation of Attention and Relaxation Levels of Archers in Shooting Process using Brain Wave Signal Analysis Algorithms” (Lee K H, Korean Journal of the Science of Emotion and Sensibility (2009)).

In the following descriptions, it is assumed that various states of mind, mental states, physical conditions of a user such as concentration, relaxation, the ZONE, and familiarity can be estimated by analyzing an electroencephalogram signal which is input from the user state estimating unit 133. However, there are various methods for estimating these user states from an electroencephalogram signal, and the gist of the technology which is disclosed in the specification is not limited to a specified estimating method. In addition, in the specification, detailed descriptions of a method of estimating a user state from an electroencephalogram signal are omitted.

Since there also exists an economic incentive such as prize money, or a sponsor fee in a computer game in a virtual world, similarly to sports in the real world, a user such as an athlete gamer has a desire to improve a performance of a game. In sports in the real world, as is referred to as “mental state, skill, and physical condition”, a state of mind, a mental state, and a physical condition of an athlete during a game have great influence on a performance in the game. Also in a computer game in a virtual world, a state of mind, a mental state, and a physical condition of a gamer have great influence on a performance in a game.

Here, each element of a performance will be taken into consideration. The “mental state” corresponds to concentration, tension, and a ZONE level of a gamer. The “skill” corresponds to reactivity, an unconscious movement, and a dynamic vision of a gamer. In addition, the “physical condition” corresponds to a physical state, drowsiness, endurance, and fatigue of a gamer. According to the embodiment, any one of the mental state, the skill, and the physical condition can be estimated based on an analysis result of an electroencephalogram signal by the user state estimating unit 133.

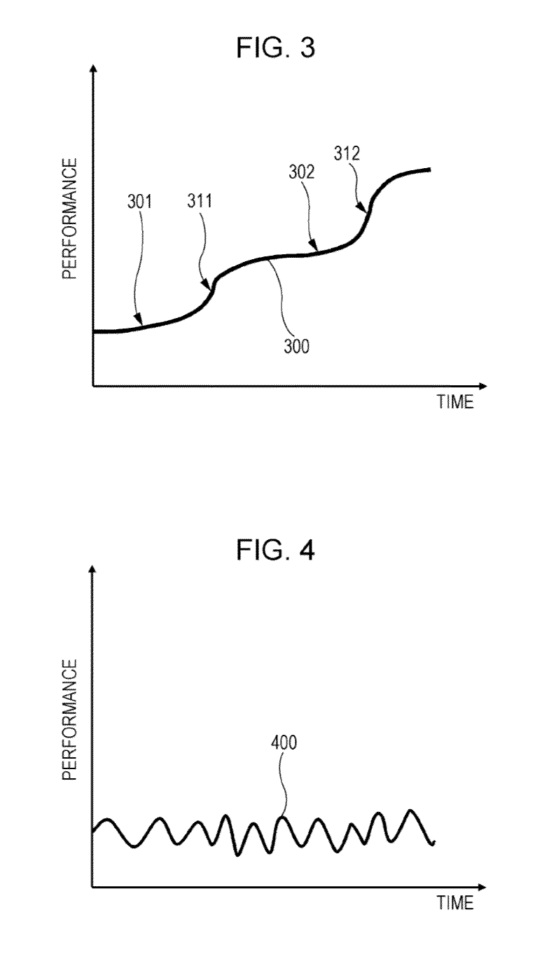

When viewing a performance of a person in the long term, the performance is improved while alternately repeating a “preparation period” in which it is hard to ascertain a result, and which is a standstill state, and a “developing period” in which a better result is obtained, without improving at a constant speed due to the training. FIG. 3 exemplifies a state (learning curve) 300 in which a performance level of a person is improved in the long term. In general, as is illustrated, it is said that it is possible to reach a level of a professional gamer by repeating an S shape which is formed of preparation periods of 301 and 302, and developing periods of 311 and 312 three times. In the specification, a performance level which is viewed in the long term is referred to as “Base”.

On the other hand, when viewing a performance level of a person in the short term, as illustrated in FIG. 4, a curve 400 in which an increase and a decrease are repeated in a short period according to a state of mind, a mental state, and a physical condition of the person is formed. The curve 400 becomes approximately constant when taking an average in time. In the specification, a performance level which is viewed in the short term is referred to as “Condition”.

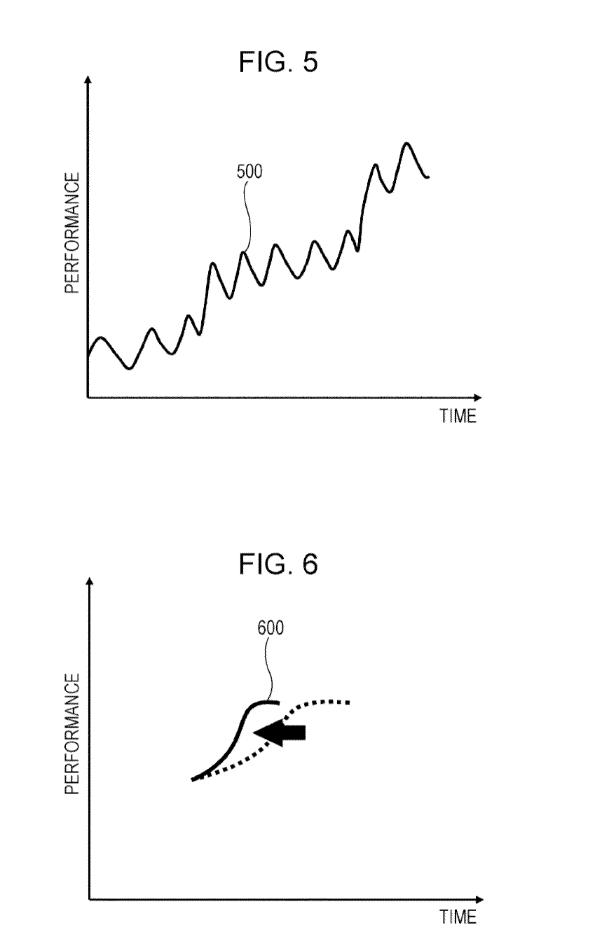

It is considered that a performance level of a person is configured of a “Base” component, and a “Condition” component. That is, as illustrated in FIG. 5, temporal transition 500 in which the “Condition” component which is formed by small amplitude and a short period is overlapped with an S-shaped learning curve which is the long term “Base” component is illustrated.

Training enhances a performance by improving a mental state, a skill, and a physical condition of a person, respectively. The improvement of a performance is divided into an improvement of the long term “Base” component and an improvement of the short term “Condition” component.

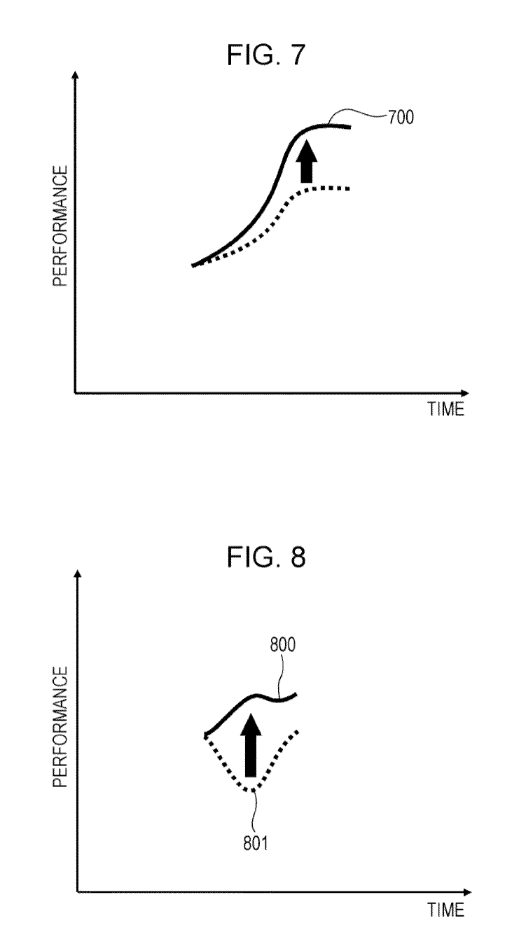

For the improvement of the long term “Base” component of a performance which is the former, it is possible to accelerate a speed of developing to the subsequent step of a learning curve 600 (or, shortening developing time) (refer to FIG. 6), and to raise a performance level in the subsequent step of a learning curve 700 (refer to FIG. 7). In addition, for the improvement of the short term “Condition” component of a performance, it is possible to enhance a level of a valley portion 801 of a learning curve 800 in a short period (refer to FIG. 8).

According to the embodiment, the user state estimating unit 133 estimates the current state of the respective mental state, skill, and physical condition by analyzing an electroencephalogram signal from the user who is playing a game. In addition, the training image generating unit 134 executes training for a game by limiting or processing a display of a part of region of a game image so as to enhance the long term “Base” component, or the short term “Condition” component with respect to each of the mental state, the skill, and the physical condition based on the state of the mental state, the skill, and the physical condition of a user which is estimated by the user state estimating unit 133.

In the specification, a “Zone Starter” is proposed as a method of training the mental state in the short term, and the “neurofeedback training” is proposed as a method of training the mental state in the long term. In addition, in the specification, “one eye warm-up” and a “field of vision guide” are proposed as methods of training the skill in the short term, and the “stroboscopic training” is proposed as a method of training the skill in the long term.

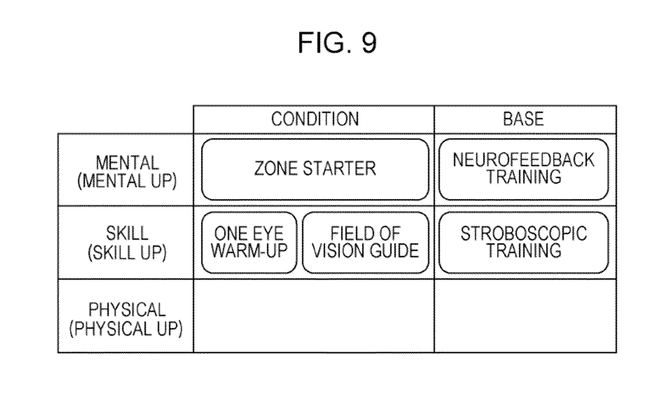

FIG. 9 collectively illustrates training methods which are proposed in the specification. However, an effect of each training method is not limited to that which is illustrated in FIG. 9. For example, there also is a case in which the “Zone Starter” becomes the long term training method of the mental state, or contributes to improving of the skill. In addition, there also is a case in which the “one eye warm-up” or the “field of vision guide” become the long term training method of the skill, or contribute to improving of the mental state.

### Example 1

### Zone Starter

The Zone Starter is a state in which both concentration (Attention) and relaxation (Meditation) are enhanced, and the best performance can be exhibited. When obtaining the degree of concentration and relaxation of a user by analyzing an input electroencephalogram signal, the user state estimating unit 133 can estimate whether or not the user is in the Zone Starter by comprehensively determining the degree of concentration and relaxation.

In addition, afterimage training in which concentration of a user is enhanced, or the user relaxes by recalling a stored image after watching an image closely for a certain period of time has been known. The Zone Starter is a training method in which the afterimage training is used, and the Zone Starter enhances Condition of the user, and causes the user to enter the ZONE level easily.

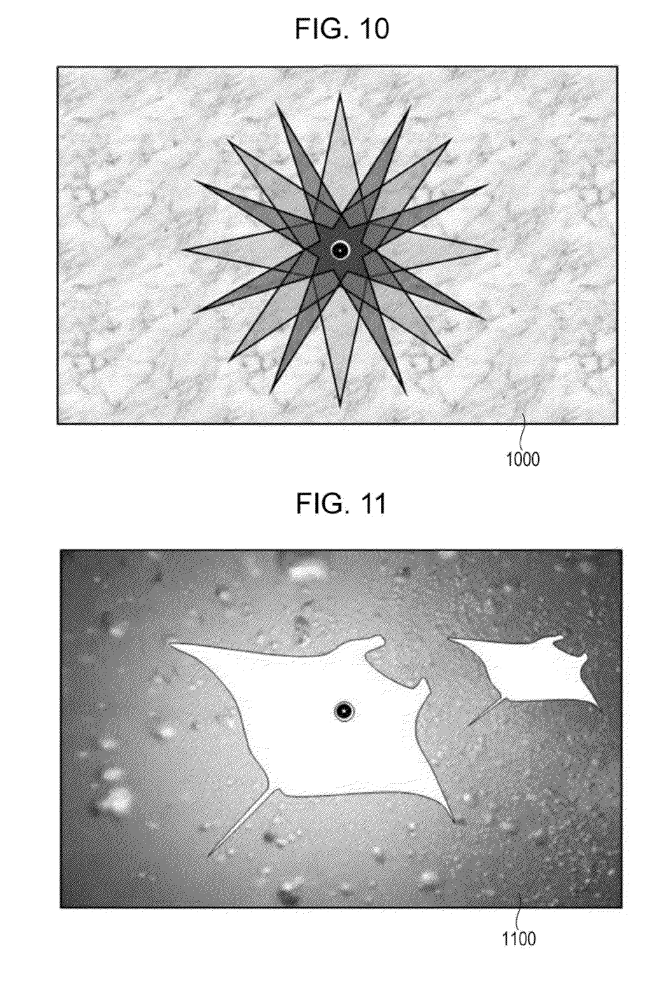

A first training image which enhances concentration when a person watches the image closely is configured of a pattern in which an afterimage floats on the back of eyelids when the person closes eyes after staring at the image in a concentrating manner, for example. A user can obtain an effect of enhancing concentration by concentrating on the training image so that an afterimage remains for a long time. FIG. 10 illustrates an example 1000 of the first training image which enhances concentration. However, the first training image which is used in the embodiment is not limited to the image illustrated in FIG. 10. In addition, it is not guaranteed that concentration is enhanced by performing training using the image 1000 which is illustrated in FIG. 10.

In addition, a second training image in which a person can be relaxed by watching the image is configured of a pattern, for example, in which, when the person continuously watches an afterimage which floats on the back of the eyelids by closing the eyes after closely watching the image, the afterimage fades out slowly. When opening the eyes slowly after the afterimage has disappeared, an effect of relaxing can be obtained due to reduced surplus energy. FIG. 11 illustrates an example of the second training image 1100 which causes relaxation. However, the second training image which is used in the embodiment is not limited to the image which is illustrated in FIG. 11. In addition, it is not guaranteed that relaxation can be obtained by performing training using the image 1100 which is illustrated in FIG. 11.

The first training image and the second training image are stored in the training image accumulating unit 135 in the image control unit 130. Alternatively, the image generation unit 110 may supply the first and second training images to the image control unit 130. In addition, when a user is not in the Zone Starter, the training image generating unit 134 displays the first training image when the user is in a state of being less attentive, and displays the second training image by reading out the image when the user is in a state of not being relaxed. In this manner, it is possible to make the user enter the ZONE easily by increasing the concentration and relaxation of the user.

The image display device 100 starts the Zone Starter, for example, when a user starts a game, when a ZONE level of the user is lowered during the game, or when the user asks for the Zone Starter using a manual operation, or the like. In addition, the image display device makes the user enter the ZONE easily by increasing the concentration and relaxation of the user by displaying the first training image when the user is in the state of being less attentive, and displaying the second training image when the user is in the state of not being relaxed.

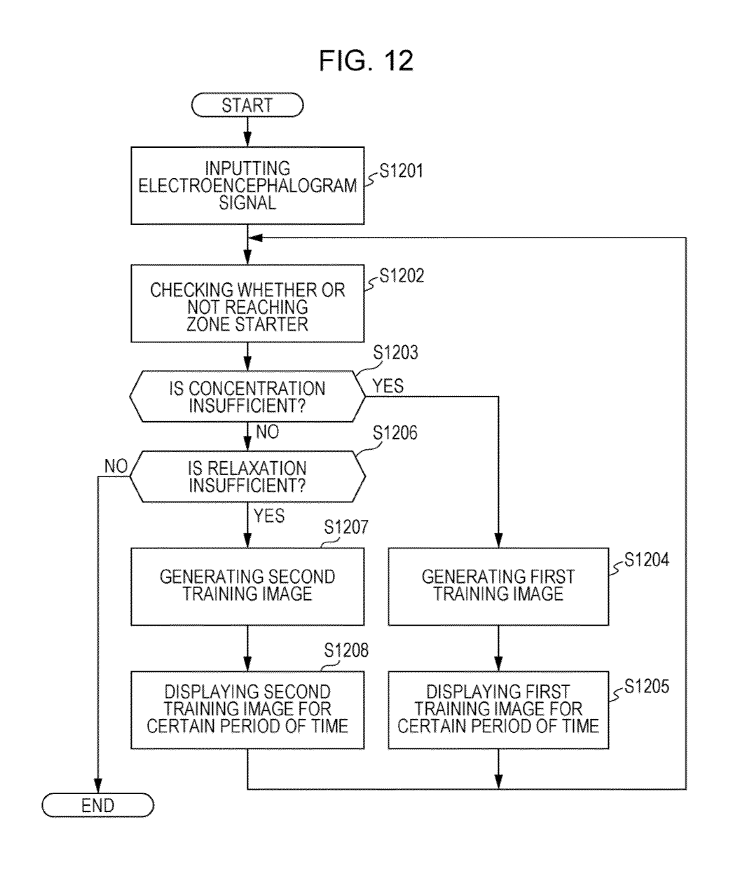

FIG. 12 illustrates processing order which is performed by the image control unit 130 in order to execute training using the Zone Starter in a form of a flowchart.

The electroencephalogram signal input unit 132 inputs electroencephalogram signals of a user which is detected in the electroencephalogram detecting unit 120 (step S1201). In addition, the user state estimating unit 133 analyzes the electroencephalogram signals, detects concentration and relaxation of the user, and checks whether or not the user is in the Zone Starter (step S1202).

Here, when it is understood that the user lacks concentration (Yes in step S1203), the training image generating unit 134 generates the first training image which enhances concentration (step S1204), displays the image on the image display unit 140 for a certain period of time (step S1205), and the process returns to step S1202 after trying to improve concentration of the user.

On the other hand, when it is understood that the user lacks concentration (Yes in step S1206), the training image generating unit 134 generates the second training image which increases relaxation (step S1207), displays the image on the image display unit 140 for a certain period of time (step S1208), and the process returns to step S1202 after trying to relax the user.

In addition, when the user is in the Zone Starter already (No in step S1206), the process routine is ended.

In FIG. 9, the Zone Starter is regarded as training which improves the short term “Condition” component of the “mental state” among elements of a performance, however, as a matter of course, an effect of improving the long term “Base” component of the “mental state”, or effects of improving other elements such as the “skill”, or the like, can be expected.

### Example 2

### Neurofeedback Training

When obtaining the degree of concentration and relaxation of a user by analyzing input electroencephalogram signals, the user state estimating unit 133 can estimate whether or not the user is in the Zone Starter by comprehensively determining the degree of concentration and relaxation (as described above). The neurofeedback training is a training method in which an estimated ZONE level is displayed on the image display unit 140 along with a game image at the same time, and is fed back. The ZONE level may be fed back using sound, or mediums other than that, in addition to displaying as an image. A user tries to make duration of the Zone Starter long when the ZONE level is fed back, a Base of a performance is enhanced, and the user enters the ZONE level easily.

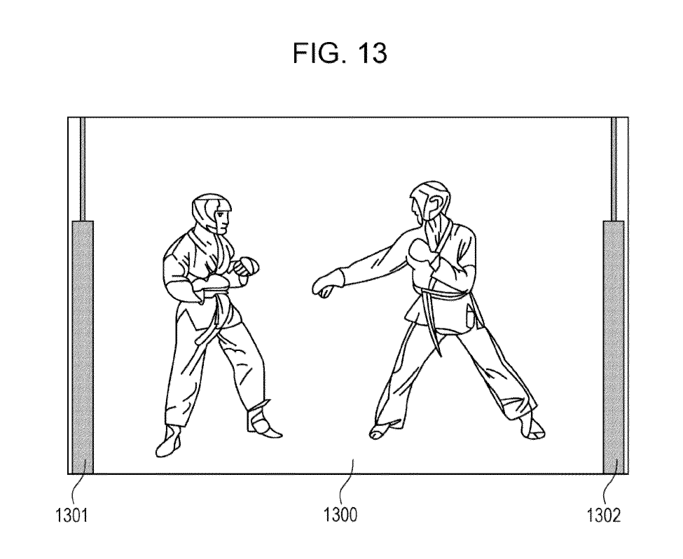

FIG. 13 illustrates a configuration example of a display image when performing the neurofeedback training. In the illustrated example, indicators 1301 and 1302 which denote estimated ZONE levels longitudinally are displayed on both the left and right of a game image 1300. The illustrated game image 1300 is an image of a fighting game. The reason why the indicators 1301 and 1302 are arranged on both the left and right ends of the image 1300 is to make confirming of a ZONE level easy by watching at least one indicator even when a line of sight of a user is in any one of the left and right directions. In addition, the indicator may be displayed on only any one end of the left and right sides. In addition, though it is not shown, the indicators may be displayed on both ends of the top and bottom, and any one end of the top and bottom of the game image, rather than on the left and right sides of the game image. As a matter of course, the indicators may be displayed on all ends on the top and bottom, and on the left and right sides, a combination of arbitrary ends such as left and right ends, or at a center rather than the end of the image.

Each of indicators 1301 and 1302 denote a level of the ZONE level with the length, and express degrees of concentration and relaxation using color. For example, when the degree of concentration is high, the indicators 1301 and 1302 are expressed using a red color, when the degree of relaxation is high, the indicators 1301 and 1302 are expressed using a blue color, and when the concentration and relaxation are balanced, the indicators 1301 and 1302 are expressed using a green color (however, in FIG. 13, color of indicators 1301 and 1302 is expressed by being switched over to shade).

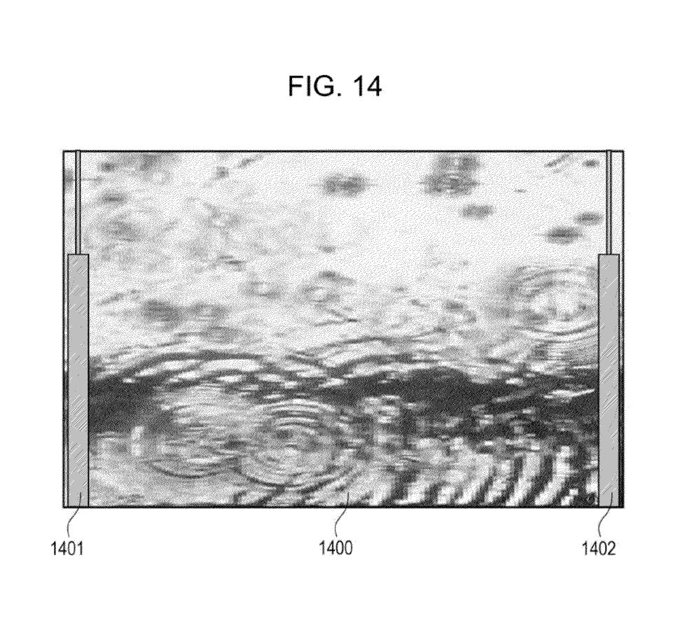

In addition, when a level of the ZONE level of the user is lower than a predetermined threshold value, or when a user asks for training of a Base component of a performance using a manual operation, or the like, the game image may be displayed by being switched over to a training image. FIG. 14 illustrates a configuration example of a screen in which training of the Base component of the performance is performed. As illustrated, the original game image is switched over to a training image 1400 which easily increases concentration (or, easily increase relaxation). In addition, similarly to FIG. 13, indicators 1401 and 1402 which denote an estimated ZONE level with length are displayed on both left and right sides. The training image 1400 is accumulated in the training image accumulating unit 135 in advance, for example, or is supplied from the image generation unit 110. The illustrated image 1400 reproduces a state in which raindrops fall and wave on the surface of water, and it is considered that it is possible to further enhance the training effect when sound of the raindrops is output along with the image. A user tries to make duration of the Zone Starter long when the ZONE level is increased when continuously watching the training image 1400, and the ZONE level is fed back, a Base of the performance is enhanced, and the user enters the ZONE level easily.

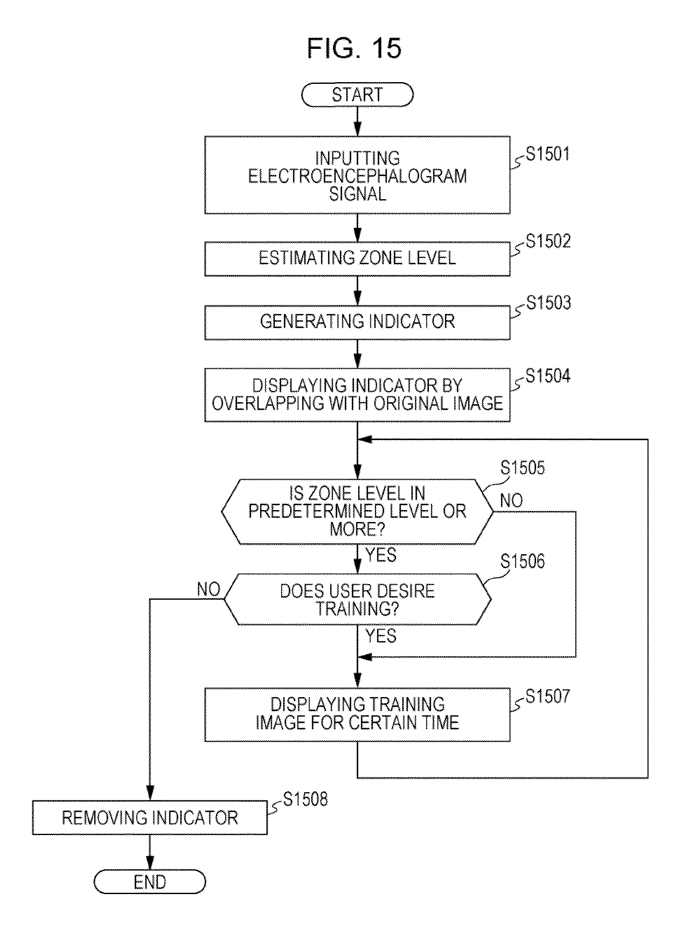

FIG. 15 illustrates processing order which is performed by the image control unit 130 in order to execute the neurofeedback training in a form of a flowchart.

The electroencephalogram signal input unit 132 inputs electroencephalogram signals of a user which are detected in the electroencephalogram detecting unit 120 (step S1501). In addition, the user state estimating unit 133 estimates the current ZONE level of the user by detecting concentration and relaxation of the user, by analyzing the electroencephalogram signals (step S1502).

The training image generating unit 134 generates indicators which denote the estimated ZONE level (step S1503), overlaps the indicators with the original game image, and displays on the image display unit 140 (step S1504). At this time, the length of the indicators denotes the ZONE level, and color denotes degrees of concentration and relaxation. For example, when the degree of concentration is high, the indicators are denoted in red, when the degree of relaxation is high, the indicators are denoted in blue, and when the concentration and relaxation are balanced, the indicators are denoted in green.

In addition, the user state estimating unit 133 checks whether or not the estimated ZONE level is maintained at a predetermined level or more (step S1505). When the estimated ZONE level is maintained at a predetermined level or more (Yes in step S1505), the user state estimating unit further checks whether or not the user desires performing of training for making the user enter the ZONE level easily (step S1506). The user is able to express a desire for the performing of training using a manual operation, or the like, for example.

Here, when the current ZONE level of the user is maintained at the predetermined level or more (Yes in step S1505), and the user does not desire further training (No in step S1506), the display of the indicators is stopped (step S1508), and the process routine is ended.

On the other hand, when the ZONE level is lower than a predetermined level (No in step S1505), and the user desires further training (Yes in step S1506), the training image generating unit 134 switches over the original game image to the training image (for example, refer to FIG. 14), displays the training image on the image display unit 140 for a certain period of time (step S1507), tries to increase the ZONE level of the user, and the process returns to step S1505.

In FIG. 9, the neurofeedback training is regarded as training which improves the long term “Base” component of the “mental state” among elements of a performance, however, as a matter of course, an effect of improving the short term “Condition” component of the “mental state”, or effects of improving other elements such as the “skill”, or the like, can be expected.

### Example 3

### One Eye Warm-Up

The one eye warm-up is a training method in which familiarity of a user with respect to a game is increased by displaying a game image only in one eye, and by spatially limiting a field of vision of the user. When a game image is alternately displayed in one eye of the left and right eyes, both eyes moves well. Accordingly, in the one eye warm-up, an effect of improving the short term “Condition” component of the “skill” among the elements of a performance is expected. The training method can be executed by assuming that the image display unit 140 can display an image separately on the left and right eyes of the user (as described above).

The user state estimating unit 133 can detect familiarity of a user with respect to a game by analyzing electroencephalogram signals of the user who is playing the game. If the one eye warm-up is performed when the familiarity of the user is lowered, a peripheral vision of the user is trained, both eyes move well, and the familiarity with respect to the game of the user is improved.

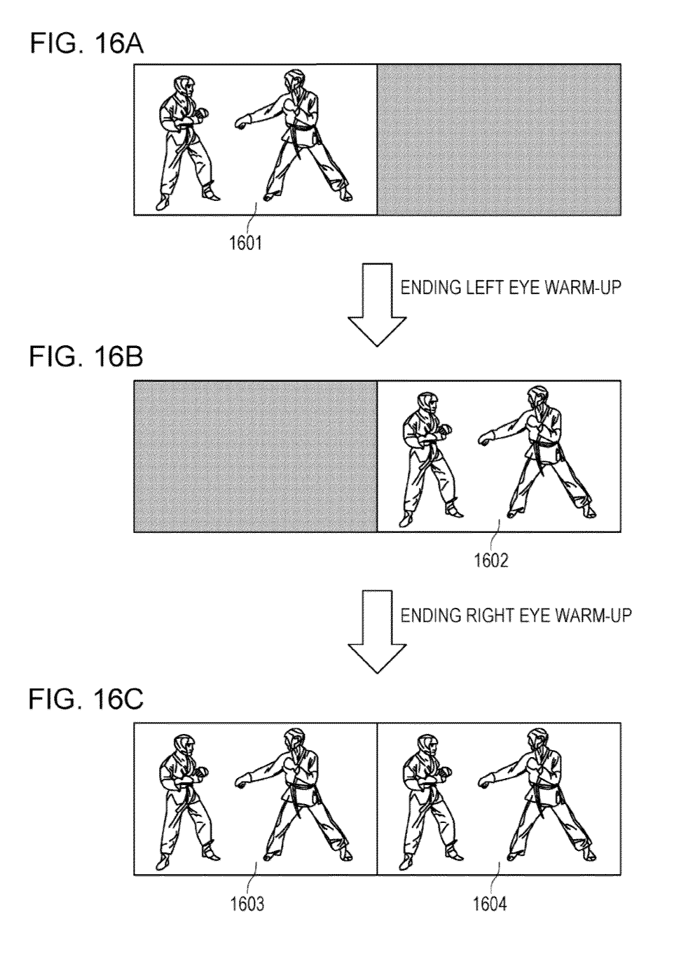

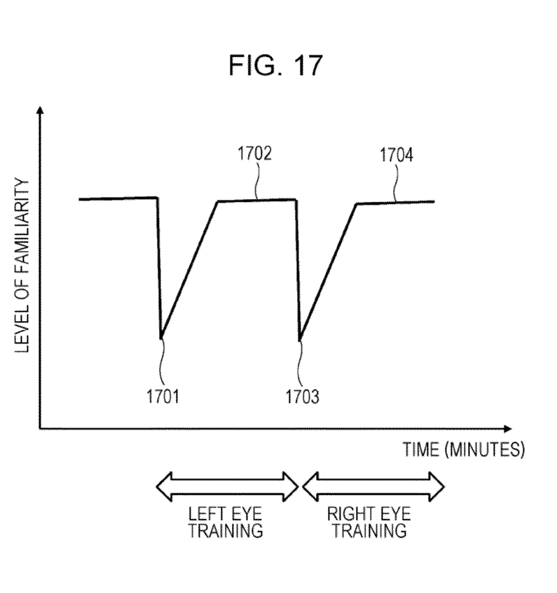

FIG. 16 illustrates a display example of an image when performing the one eye warm-up. In addition, FIG. 17 illustrates a transition in familiarity of a user when performing the one eye warm-up.

First, as illustrated in FIG. 16A, a game image 1601 is displayed only in the left eye, and a field of vision in the right eye is limited. As a result, familiarity which is estimated in the user state estimating unit 133 is temporarily lowered as is denoted by a reference number 1701 in FIG. 17, recovers gradually, recovers up to a level of the original familiarity 1702 after a certain period of time, and the warm-up in the left eye is ended.

In addition, when warm-up on the left eye is ended, as illustrated in FIG. 16B, a game image 1602 only for the right eye is displayed at this time, and a field of vision in the left eye is limited. As a result, the familiarity which is estimated in the user state estimating unit 133 is temporarily lowered as illustrated in the reference number 1703 in FIG. 17, however, the familiarity gradually recovers, recovers to a level of the original familiarity 1704 after a certain period of time, and the warm-up in the right eye is ended.

In addition, it is assumed that a couple of minutes are necessary per one eye warm-up.

In this manner, when the warm-up for the respective left and right eyes is ended, the limit in a field of vision in one eye is released, and as illustrated in FIG. 16C, game images 1603 and 1604 are displayed in the left and right eyes. Since the peripheral field of vision of a user is trained, and both eyes move well, the familiarity with respect to the game is increased.

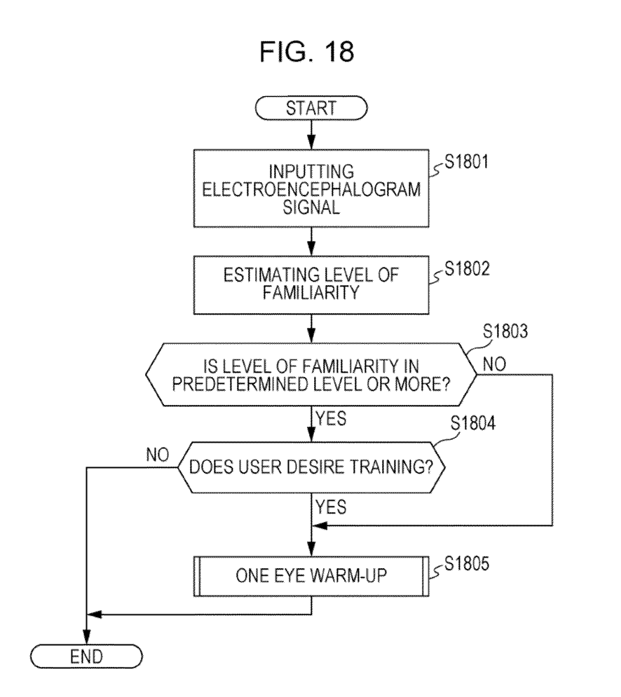

FIG. 18 illustrates processing order which is performed by the image control unit 130 for executing the one eye warm-up in a form of a flowchart.

The electroencephalogram signal input unit 132 inputs electroencephalogram signals which are detected from a user who is playing a game by the electroencephalogram detecting unit 120 (step S1801). In addition, the user state estimating unit 133 analyzes the electroencephalogram signals, and estimates familiarity of the user with respect to the game (step S1802).

The user state estimating unit 133 checks whether or not the estimated familiarity is maintained at a predetermined level or more (step S1803). In addition, when the familiarity is maintained at a predetermined level or more (Yes in step S1803), the user state estimating unit further checks whether or not the user desires a further improvement of the familiarity, that is, one eye warm-up (step S1804). It is assumed that the user is able to express that he wants to perform training for improving the familiarity through a manual operation, for example.

Here, when the current familiarity of the user is maintained at a predetermined level or more (Yes in step S1803), and the user does not desire the training for improving the familiarity (No in step S1804), the process routine is ended.

On the other hand, when the current familiarity is lower than a predetermined level (No in step S1803), and the user desires further training (Yes in step S1804), the one eye warm-up is performed (step S1805).

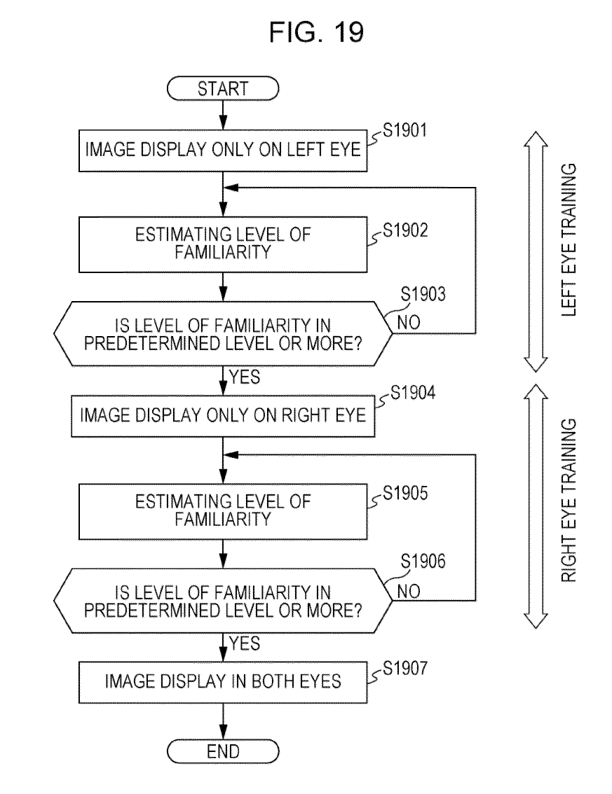

FIG. 19 illustrates detailed processing order of the one eye warm-up which is performed in step S1805 in a form of a flowchart.

First, a display of a game image on the right eye is stopped, a field of vision of a user is limited only to the left eye, and warm-up in the left eye is performed (step S1901). In addition, a level of familiarity with respect to a game of the user is estimated by analyzing electroencephalogram signals which are detected from the user who is playing the game using one eye (step S1902), and a display only in the left eye (that is, left eye training) is continued until the familiarity recovers to a predetermined level (No in step S1903).

Thereafter, when the familiarity of the user recovers to a predetermined level (Yes in step S1903), a display of the game image in the right eye is started, the display of the game image in the left eye is stopped (step S1904), and the warm-up is switched to warm-up in the right eye, at this time.

In addition, the level of familiarity of the user with respect to the game is estimated by analyzing electroencephalogram signals which are detected from the user who is playing the game using one eye (step S1905), and a display only in the right eye (right eye training) is continued until the familiarity recovers to a predetermined level (No in step S1906).

Thereafter, when the familiarity of the user recovers to a predetermined level (Yes in step S1906), the process returns to a display of the game image in both eyes (step S1907), and the process routine is ended.

In FIG. 9, the one eye warm-up is regarded as training which improves the short term “Condition” component of the “skill” among the elements of a performance, however, as a matter of course, an effect of improving the long term “Base” component of the “skill”, or an effect of improving other elements such as the “mental state” can also be expected.

### Example 4

### Field of Vision Guide

A field of vision guide is a training method which increases concentration of a user with respect to a game by presenting information which guides a field of vision of the user in a game image. For example, training is performed by limiting a display of a part of a game image (for example, region which is not necessarily notable), or displaying a guide which can be focused at a place which will be viewed by a user. In the field of vision guide, an effect of improving the short term “Condition” component of the “skill” among the elements of a performance can be expected.

The user state estimating unit 133 can detect concentration of a user with respect to a game by analyzing electroencephalogram signals of the user who is playing the game. When a field of vision guide is presented in a case in which concentration of a user is lowered, the user can closely watch a portion to be closely watched, and a response to the game of the user is increased.

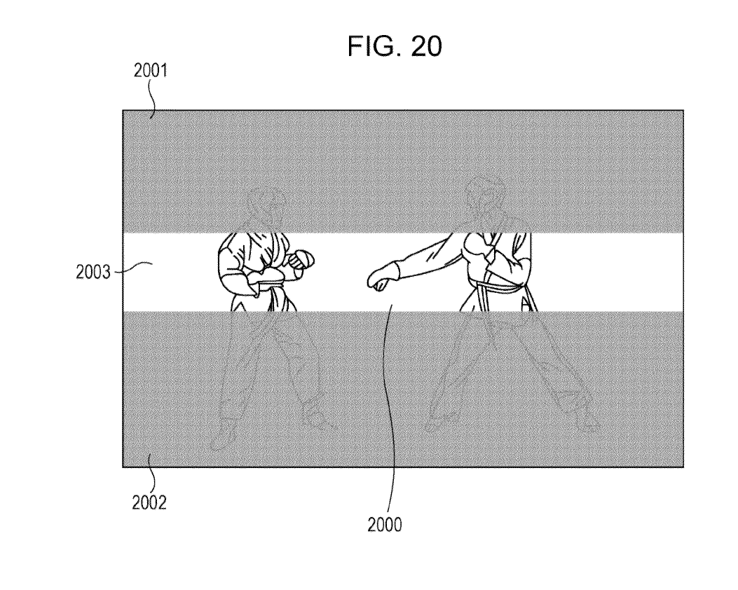

For example, in a fighting game, a character changes a posture from a basic standing posture to a crouching posture, and to a jumping posture. Since the upper half of the body of the character is largely moved when the character changes his standing posture, it is possible to easily notice a movement of the character by closely watching the upper half of the body. Accordingly, in the point of view of an attack and guard, closely watching the upper half of the body of an opponent is one of secrets of improving. Accordingly, by presenting a field of vision guide in which close watching of the upper half of the body of the opponent is possible, or a field of vision guide which causes the upper half of the body to be closely watched by limiting or blocking a field of vision in portions other than that, a response of a user with respect to a game is increased, and it is possible to increase concentration. Display examples of the field of vision guides in images of a fighting game are respectively illustrated in FIGS. 20 to 22.

In the example which is illustrated in FIG. 20, a gaze region 2003 corresponding to the height of the upper half of the body of the opponent is formed by providing translucent field-of-vision limiting regions 2001 and 2002 which limit a field of vision at the top and bottom of the original fighting game image 2000 which interpose the upper half of the body of the opponent therebetween. In the field-of-vision limiting regions 2001 and 2002, the gaze region 2003 is caused to be further closely watched by gradually lowering transmissivity of the gaze region 2003 when being deviated therefrom.

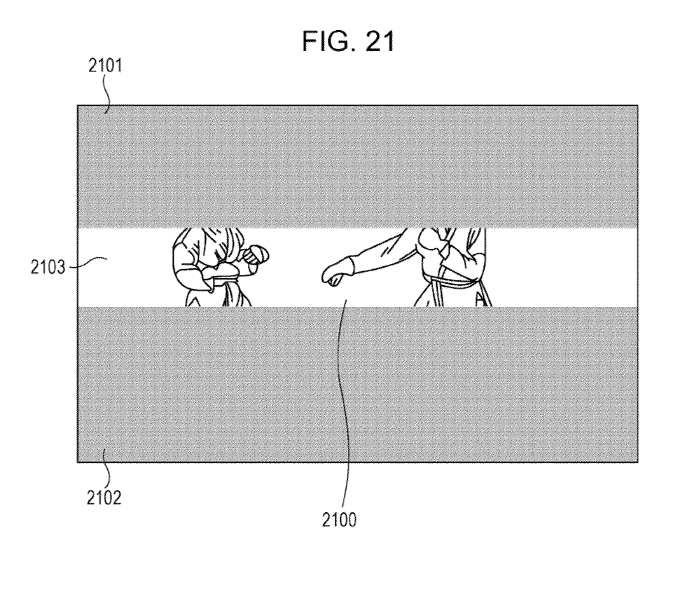

In the example which is illustrated in FIG. 21, a gaze region 2103 corresponding to the height of the upper half of the body of the opponent is formed by providing field-of-vision blocking regions 2101 and 2102 which limit a field of vision at the top and bottom of the original fighting game image 2100 which interpose the upper half of the body of the opponent therebetween. Since portions which are deviated from the upper half of the body in the game image 2100 are completely invisible in the field-of-vision blocking regions 2101 and 2102, a user necessarily watches the gaze region 2103 closely, and a response to a movement of the upper half of the body of the opponent (attack) in the gaze region 2103 is increased.

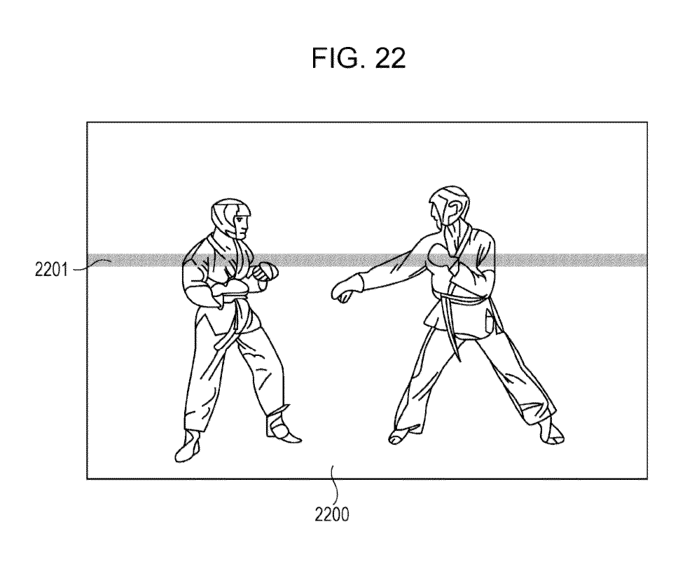

In the example which is illustrated in FIG. 22, a field of vision guide 2201 which is formed by a horizontal line which passes through the vicinity of the upper half of the body of the opponent in the original game image 2200 is displayed. A response of a user to a movement (attack) of the upper half of the body of the opponent is increased by gazing at the height of the upper half of the body of the opponent with an aid of the field of vision guide 2201.

Since the field of vision guide 2201 illustrated in FIG. 22 is not provided with the field-of-vision limiting region, or the field-of-vision blocking region like the example which is illustrated in FIG. 20, or FIG. 21, it is possible to guide a line of sight of a user to a place to be closely watched without damaging the original game image a lot.

Whether or not to use a pattern of any one of the field of vision guides in FIGS. 20 to 22 may be selected by a user. In addition, a display form of the field of vision guide may be actively switched according to a change in concentration of a user. For example, the field of vision guide 2201 illustrated in FIG. 22 may be displayed in a translucent state, using a light color, or a thinner line when concentration of a user is not much lowered, and be displayed using a dark color, a color which raises attention such as a red color, or a thicker line when the concentration of the user is remarkably lowered.

In addition, a music game is a game in which playing of music is made to a game, and is performed when a musical instrument is played according to a rhythm or music. In an image of a music game, an operation unit which is formed by, for example, an image in which a musical instrument is imitated, or the like, is displayed at a place corresponding to a current time on a time axis (for example, in vicinity of terminal of time axis) by setting the vertical direction, or the horizontal direction on a screen as the time axis, in general. Accordingly, when a field of vision guide which guides a line of sight of a user is displayed in the vicinity of the operation unit in an image of the music game, the user watches the operation unit closely, and a response is increased.

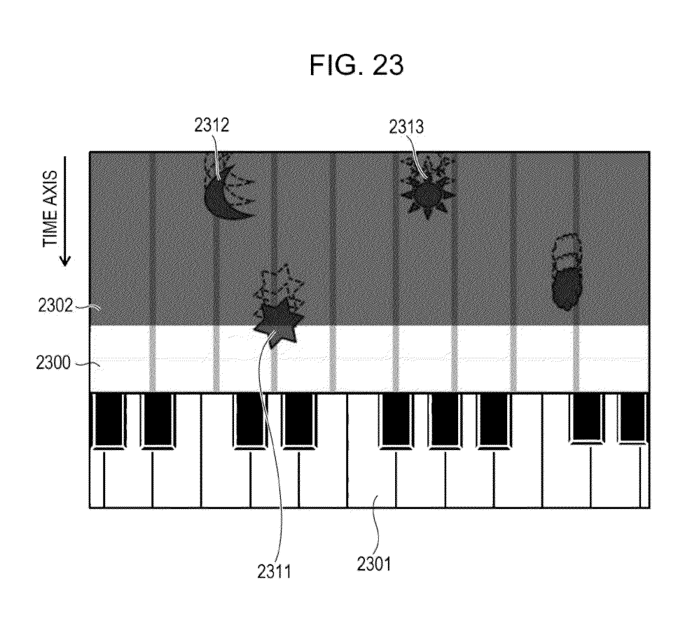

FIG. 23 illustrates a display example of a field of vision guide in an image in a music game. An image 2300 of the illustrated music game is arranged with an operation unit 2301 with which a user performs an operation of a performance at a terminal of a time axis corresponding to the current time, that is, the lower end of a screen, by setting the vertical direction of the screen as the time axis. In the illustrated example, the operation unit 2301 is formed by a piano keyboard. In addition, one or more objects 2311, 2312, 2313, . . . which fall toward the operation unit 2301 are displayed from the upper part of the screen. In addition, operating of a corresponding keyboard according to a musical score is imposed on a user, that is, a player as a rule of the music game.

In the image 2300 of the music game, since there is no object which is operated by a user in a region in the upper part of the operation unit 2301, it is not necessary to closely watch the region. In addition, colliding of the falling objects 2311, 2312, 2313, . . . with the keyboard as the operation unit 2301 is a thing to come. In the music game, a timing of operating the keyboard by being synchronized with a current time is important, however, on the other hand, information in the future such as the falling objects 2311, 2312, 2313, . . . is not necessary. Therefore, in the example which is illustrated in FIG. 23, a field of vision is limited so that information in the future is hardly viewed by providing a field-of-vision limiting region 2302 which is translucent or opaque at the upper part of the operation unit 2301. In this manner, since the user concentrates on operations of the piano keyboard by closely watching the operation unit 2301, a response to the game is increased.

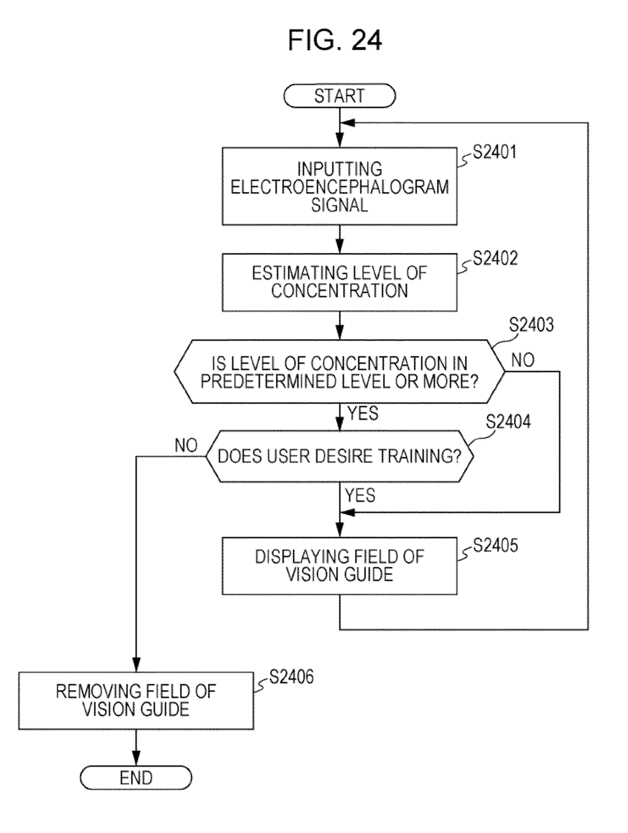

In FIG. 24 processing order which is performed by the image control unit 130 in order to execute the field of vision guide is illustrated in a form of a flowchart.

The electroencephalogram signal input unit 132 inputs electroencephalogram signals which are detected from a user who is playing a game by the electroencephalogram detecting unit 120 (step S2401). In addition, the user state estimating unit 133 estimates concentration of the user with respect to the game by analyzing the electroencephalogram signals (step S2402).

The user state estimating unit 133 checks whether or not the estimated concentration is maintained at a predetermined level or more (step S2403). In addition, when the concentration is maintained at a predetermined level or more (Yes in step S2403), whether or not the user desires a further improvement, that is, a display of a field of vision guide is further checked (step S2404). It is assumed that the user is able to express a desire of performing training which improves concentration using a manual operation, for example.

Here, when current concentration of the user is maintained at a predetermined level or more (Yes in step S2403), and the user does not desire the training which improves concentration (No in step 2404), the process routine is ended.

On the other hand, when the current concentration of the user is lower than a predetermined level (No in step S2403), and the user desires further training (Yes in step S2404), the field of vision guide is executed (step S2405).

In step S2405, as described above, a user is able to select a pattern of any one of field of vision guides, which will be used (for example, any one in FIGS. 20 to 22 in case of fighting game). In addition, a display form of the field of vision guide may be actively switched according to a change in concentration of the user.

In addition, when a current concentration of a user is improved to a predetermined level or more (Yes in step S2403), and the user does not desire the field of vision guide (No in step S2404), a display of the field of vision guide is stopped (step S2406), and the process routine is ended.

In FIG. 9, the field of vision guide is regarded as training for improving the short term “Condition” component of the “skill” among the elements of a performance, however, as a matter of course, it is also possible to expect an effect of improving the long term “Base” component of the “skill”, or an effect of improving other elements such as the “mental state”.

### Example 5

### Stroboscopic Training

The one eye warm-up is a training method (described above) in which familiarity of a user with respect to a game is improved by spatially limiting a field of vision of a user. In contrast to this, stroboscopic training is a training method in which familiarity of a user with respect to a game is improved by limiting a field of vision of a user in time. Specifically, when a field of vision of a user is limited in time using a stroboscope, that is, by shielding a game image at every fixed interval, a predicting ability of a user from a slight movement in the game is improved. Accordingly, in the stroboscopic training, it is possible to expect an effect of improving the long term “Base” component of the “skill” among the elements of a performance.

The user state estimating unit 133 can detect familiarity of a user with respect to a game by analyzing electroencephalogram signals from the user who is playing the game. If the stroboscopic training is performed when the familiarity of the use is lowered, the user is able to predict from the slight movement of the game image, and the familiarity with respect to the game is improved.

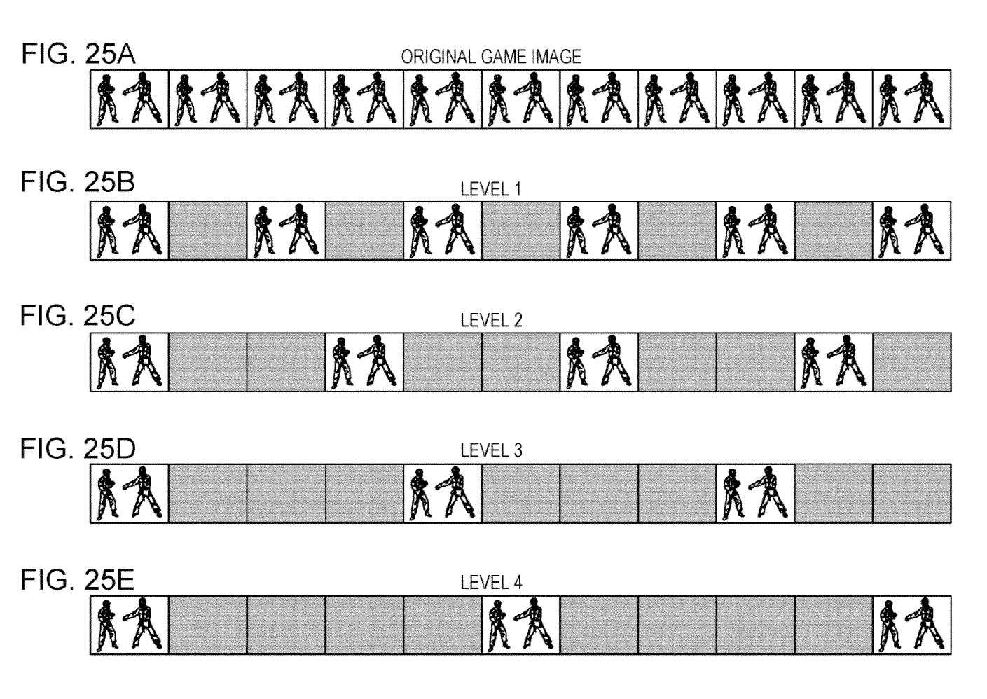

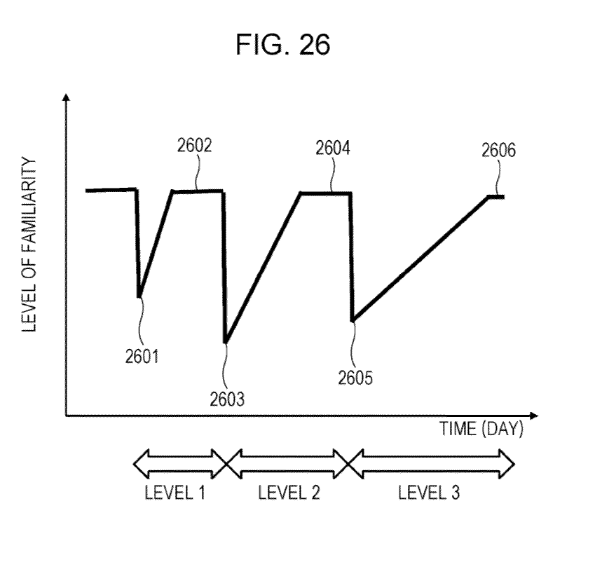

FIG. 25 illustrates a display example of an image when performing the stroboscopic training. In addition, FIG. 26 illustrates a transition of familiarity of a user when performing the stroboscopic training.

When the stroboscopic training is not performed, as illustrated in FIG. 25A, a game image is usually displayed. In contrast to this, when the stroboscopic training is performed, the game image is shielded at every fixed interval as illustrated in FIGS. 25B to 25E, and a field of vision of a user is limited in time. When the interval of shielding the game image is longer, it is necessary for a user to have a better ability of predicting from a slight movement of the game image. In other words, the longer the interval of shielding the game image, the higher the level of the stroboscopic training.

Here, a level 1 in which the stroboscopic training of shielding the game image is performed for a period of ½ (refer to FIG. 25B), a level 2 in which the stroboscopic training of shielding the game image is performed for a period of ⅔ (refer to FIG. 25C), a level 3 in which the stroboscopic training of shielding the game image is performed for a period of ¾ (refer to FIG. 25D), and a level 4 in which the stroboscopic training of shielding the game image is performed for a period of ⅘ (refer to FIG. 25E) are respectively defined. When performing the stroboscopic training of a higher level, the predicting ability becomes higher.

When the stroboscopic training is started, first, a stroboscopic training image of the level 1 which is illustrated in FIG. 25B is displayed. Thereupon, familiarity which is estimated in the user state estimating unit 133 is temporarily lowered as denoted in the reference number 2601 in FIG. 26, however, the familiarity gradually recovers.

When the familiarity recovers to a predetermined level 2602, subsequently, a stroboscopic training image of the level 2 which is illustrated in FIG. 25C is displayed. Thereupon, familiarity which is estimated in the user state estimating unit 133 is temporarily lowered as denoted in the reference number 2603 in FIG. 26, however, the familiarity gradually recovers.

When the familiarity recovers to a predetermined level 2604, subsequently, a stroboscopic training image of the level 3 which is illustrated in FIG. 25D is displayed. Thereupon, familiarity which is estimated in the user state estimating unit 133 is temporarily lowered as denoted in the reference number 2605 in FIG. 26, however, the familiarity gradually recovers to a predetermined level 2606.

In addition, it is assumed that the stroboscopic training in each level takes a time of use of approximately a few days. It is expected that when the level of the training is higher, the familiarity at a time of transiting a level is remarkably lowered, or the time of use for recovering the familiarity become longer.

In FIG. 26, an example in which the stroboscopic training of the level 1 to level 3 are performed is illustrated, however, stroboscopic training of a level 4 and thereafter may be continuously performed, or the stroboscopic training may be stopped at the level 2 in contrast to this according to a desire of a user, circumstances of a system operation, or the like. In addition, the stroboscopic training may be started at the level 2, or a level which is higher than that, rather than from the level 1. In addition, the level of the stroboscopic training may be raised by two steps or more at a time, without being raised step by step. In addition, in the interest of time, or the like, only stroboscopic training of one specified level may be performed, without performing the stroboscopic training of a plurality of levels.

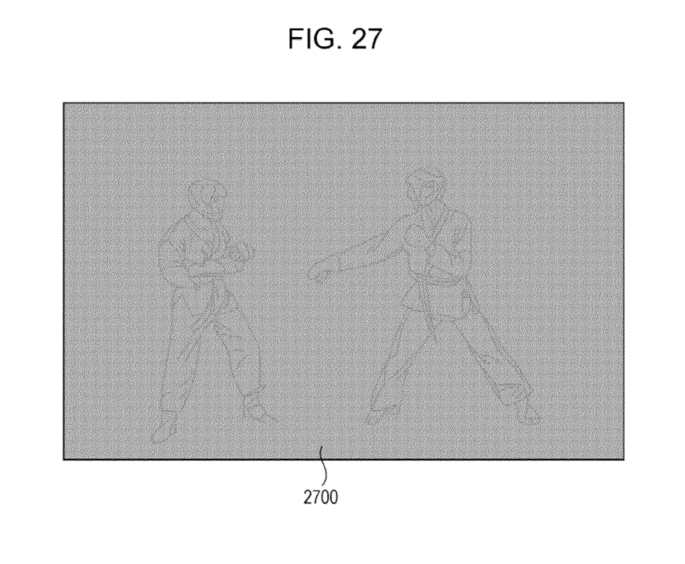

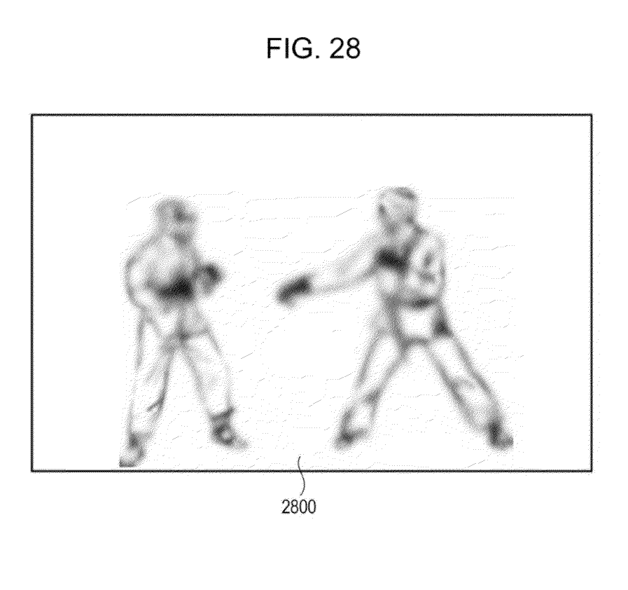

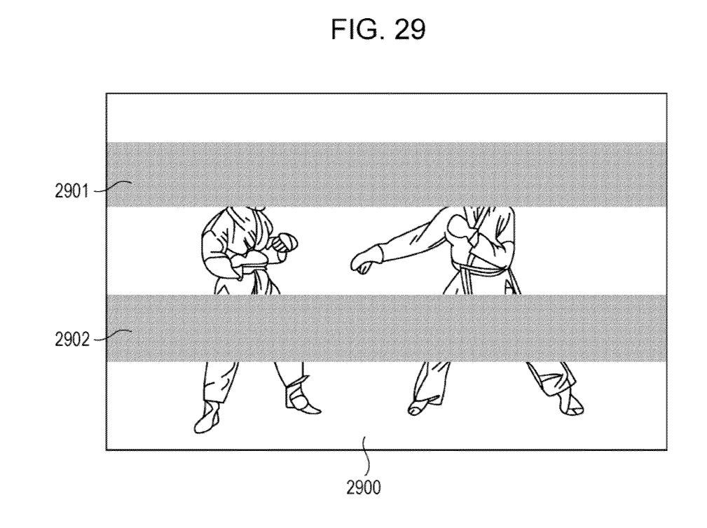

In addition, in the examples which are illustrated in FIGS. 25A to 25E, it is assumed that an invalid image such as a black image is displayed in a period of shielding the game image, however, it is not limited to this. For example, an image in which a field of vision of the original game image is spatially limited such as an image 2700 in which the original game image is viewed through (refer to FIG. 27), an image 2800 in which the original game image is blurred (refer to FIG. 28), an image in which the original game image 2900 is partially blocked using one or more field-of-vision blocking images 2901, 2902, . . . (refer to FIG. 29), an image in which the original game image is temporarily stopped in every predetermined time (not shown), or the like, may be displayed in a period of shielding the game image. In addition, in each example in FIGS. 27 to 29, the original game image may become closer to the black image by changing degree of blurring, transmissivity, or a size of a field-of-vision blocking region with lapse of time.

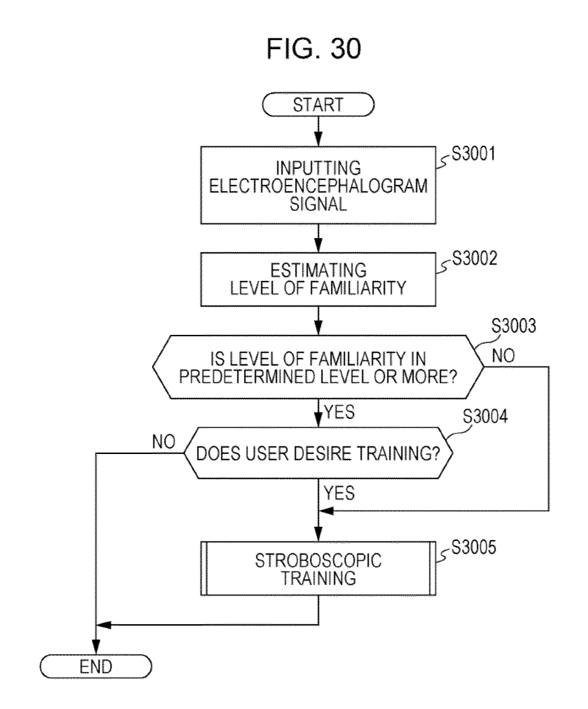

FIG. 30 illustrates processing order which is performed by the image control unit 130 in order to execute the stroboscopic training in a form of a flowchart.

The electroencephalogram signal input unit 132 inputs electroencephalogram signals which are detected from a user who is playing a game by the electroencephalogram detecting unit 120 (step S3001). In addition, the user state estimating unit 133 estimates familiarity of the user with respect to the game by analyzing the electroencephalogram signals (step S3002).

The user state estimating unit 133 checks whether or not the estimated familiarity is maintained at a predetermined level or more (step S3003). In addition, when the familiarity is maintained at a predetermined level or more (Yes in step S3003), whether or not the user desires a further improvement of the familiarity, that is, the stroboscopic training is further checked (step S3004). It is assumed that it is possible for a user to express a desire of performing training which improves the familiarity using a manual operation, for example.

Here, when a current familiarity of the user is maintained at a predetermined level or more (Yes in step S3003), and the user does not desire the training which improves the familiarity (No in step S3004), the process routine is ended.

On the other hand, when the current familiarity of the user is lower than a predetermined level (No in step S3003), and the user desires further training (Yes in step S3004), the stroboscopic training is performed (step S3005).

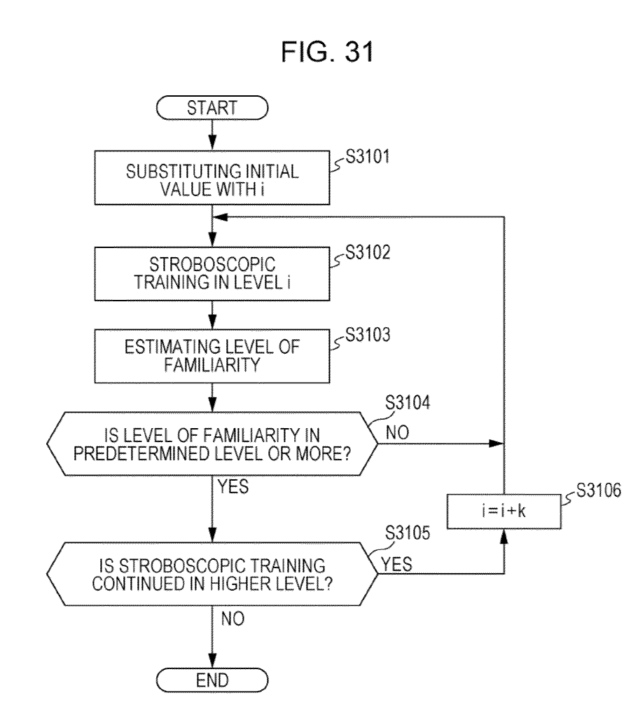

FIG. 31 illustrates detailed processing order of the stroboscopic training which is performed in step S3005 in a form of a flowchart.

First, a predetermined initial value is substituted with i (step S3101), and stroboscopic training in a specific level i is performed (step S3102). When the stroboscopic training is started from the level 1, an initial value 1 is substituted with i. In addition, a level of familiarity of a user with respect to a game is estimated (step S3103) by analyzing electroencephalogram signals which are detected from a user who is in the stroboscopic training, and the stroboscopic training in the level i is continued until the familiarity recovers to a predetermined level (No in step S3104).

Thereafter, when the familiarity of the user recovers to a predetermined level (Yes in step S3104), whether or not to continue the stroboscopic training in a higher level is checked (step S3105). For example, it is assumed that it is possible for the user to express a desire of performing the stroboscopic training in the higher level using a manual operation, or the like.

Here, when it is not necessary to continue the stroboscopic training in the higher level (No in step S3105), the process routine is ended.

On the other hand, when it is necessary to continue the stroboscopic training in the higher level (Yes in step S3105), i is subject to being incremented by k (step S3106), the process returns to step S3102, and stroboscopic training in the subsequent level is continuously performed. k is set to 1 when the level is raised step by step, and is set to 2 when the level is raised by two steps.

In FIG. 9, the stroboscopic training is regarded as training which improves the long term “Base” component of the “skill” among elements of a performance, however, as a matter of course, an effect of improving the short term “Condition” component of the “skill”, or effects of improving other elements such as the “mental state”, or the like, can also be expected.

In addition, the technology which is disclosed in the specification can also be configured as follows.

(1) An image display device including:

a control device to estimate a user state based on a detected electroencephalogram signal of a user who is playing a game, and to control display of an image to the user for providing training for the game based on the user state.

(2) The image display device according to (1),

wherein the user state is estimated as a zone starter state based on concentration and relaxation of the user indicated by the detected electroencephalogram signal.

(3) The image display according to (1) or (2),

wherein, when a result of a determination of whether the user state is in the zone starter state indicates lack of concentration, the control device controls display so that the image is displayed to the user, in which the image enhances concentration.

(4) The image display device according to any one of (1) to (3),

wherein, when a result of a determination of whether the user state is in the zone starter state indicates lack of relaxation, the control device controls display so that the image is displayed to the user, in which the image increases relaxation.

(5) The image display device according to any one of (1) to (4),

wherein, when a zone level indicating degree of concentration or relaxation of the user indicated by the detected electroencephalogram signal is less than a predetermined level, the control device controls display so that the image is displayed to the user.

(6) The image display device according to any one of (1) to (5), wherein,

when a level of familiarity of the user with respect to the game indicated by the detected electroencephalogram signal is less than a predetermined level, the control device controls display so that the image is displayed only in one eye of the user.

(7) The image display device according to any one of (1) to (6),

wherein the image display device is a head mounted display.

(8) The image display device according to any one of (1) to (7),

wherein, when a level of concentration of the user indicated by the detected electroencephalogram signal is less than a predetermined level, the control device controls display so that the image is displayed to the user, the image being in accordance with a field of vision guide.

(9) The image display device according to any one of (1) to (8),

wherein, when a level of familiarity of the user with respect to the game indicated by the detected electroencephalogram signal is less than a predetermined level, the control device controls display of the image at every interval of a plurality of predetermined fixed intervals and at least one other image different than the image in a period between consecutive ones of the predetermined fixed intervals.

(10) An image display method including:

estimating, by a control device, a user state based on a detected electroencephalogram signal of a user who is playing a game, and controlling, by the control device, display of an image to the user for providing training for the game based on the user state.

(11) A non-transitory recording medium recorded with a program executable by a computer, the program including:

estimating a user state based on a detected electroencephalogram signal of a user who is playing a game, and controlling display of an image to the user for providing training for the game based on the user state.

(12) An information processing apparatus including:

a control device to: estimate a user state based on a detected electroencephalogram signal of a user who is playing a game, in which the detected electroencephalogram signal is provided from an external device over a communication network, and control providing, over the communication network, of a display signal to control display of an image to the user for providing training for the game based on the user state.

(13) An image display device which includes an electroencephalogram detecting unit which detects electroencephalograms of a user, and an image control unit which controls a game image which is presented to the user based on a detection result of the electroencephalogram.

(14) In the device which is described in (13), the image control unit controls the game image which is presented to the user based on a result in which any one of a state of mind, a mental condition, and a physical condition of the user is estimated on the basis of the electroencephalogram.

(15) In the device which is described in (13), the image control unit displays an image for performing training for a game by the user, by limiting or processing a part, or the whole of the original game image.

(16) In the device which is described in (13), the image control unit performs the training for the game for improving a ZONE level according to a ZONE level of the user which is estimated from the electroencephalogram.

(17) In the device which is described in (16), the image control unit presents a first training image which improves concentration of the user in order to make the user reach the ZONE level when the user lacks concentration.

(18) In the device which is described in (16), the image control unit presents a second training image for relaxation of the user when the user is nervous, in order to make the user reach the ZONE level.

(19) In the device which is described in (13), the image control unit presents to the user a ZONE level which is estimated based on a detection result of the electroencephalogram.

(20) In the device which is described in (19), the image control unit displays an indicator which denotes the ZONE level using a length at least on one end of left and right and top and bottom of the game image.

(21) In the device which is described in (20), the image control unit changes a display color of the indicator according to changes in the concentration and relaxation of the user which are estimated from the electroencephalogram.

(22) In the device which is described in (20), the image control unit displays the game image by replacing the image with a training image which improves the ZONE level according to a decrease in the ZONE level of the user.

(23) In the device which is described in (13), the image control unit displays the game image only in one eye of the user according to familiarity of the user which is estimated from the electroencephalogram.

(24) In the device which is described in (23), the image control unit displays the game image only in one eye of left and right eyes of the user, and displays the game image only in the other eye when the familiarity of the user is improved.

(25) In the device which is described in (13), the image control unit displays information which induces a line of sight of the user in the game image according to the concentration of the user which is estimated from the electroencephalogram.

(26) In the device which is described in (25), the image control unit displays a region which limits a field of vision, or shields the field of vision, except for a portion to which attention is paid in the game image.

(27) In the device which is described in (25), the image control unit displays a field of vision guide for causing eye contact with the portion to which attention is paid in the game image.

(28) In the device which is described in (27), the image control unit changes a display form of the field of vision guide according to a change in the concentration of the user.

(29) In the device which is described in (13), the image control unit limits the field of vision of the user in time by blocking the game image at every fixed interval according to the familiarity of the user which is estimated from the electroencephalogram.

(30) In the device which is described in (29), the image control unit sets the interval of blocking the game image to be long when the familiarity of the user is increased.

(31) In the device which is described in (29), the image control unit displays any one of a black image, an image in which the original game image is blurred, an image in which a part of the original game image is shielded, and an image in which a display of the original game image is temporarily stopped, in a period of time in which the game image is shielded.

(32) An image display method which includes detecting an electroencephalogram of a user, and controlling a game image which is presented to the user based on a detection result of the electroencephalogram.

It should be understood by those skilled in the art that various modifications, combinations, sub-combinations and alterations may occur depending on design requirements and other factors insofar as they are within the scope of the appended claims or the equivalents thereof.

What is claimed is:

1. An image display device comprising:
a control device to estimate a user state based on a detected electroencephalogram signal of a user who is playing a game, and to control display of an image to the user for providing training for the game based on the user state.

2. The image display device of claim 1, wherein the user state is estimated as a zone starter state based on concentration and relaxation of the user indicated by the detected electroencephalogram signal.

3. The image display device of claim 2, wherein, when a result of a determination of whether the user state is in the zone starter state indicates lack of concentration, the control device controls display so that the image is displayed to the user, in which the image enhances concentration.

4. The image display device of claim 2, wherein, when a result of a determination of whether the user state is in the zone starter state indicates lack of relaxation, the control device controls display so that the image is displayed to the user, in which the image increases relaxation.

5. The image display device of claim 1, wherein, when a zone level indicating degree of concentration or relaxation of the user indicated by the detected electroencephalogram signal is less than a predetermined level, the control device controls display so that the image is displayed to the user.

6. The image display device of claim 1, wherein, when a level of familiarity of the user with respect to the game indicated by the detected electroencephalogram signal is less than a predetermined level, the control device controls display so that the image is displayed only in one eye of the user.

7. The image display device of claim 6, wherein the image display device is a head mounted display.

8. The image display device of claim 1, wherein, when a level of concentration of the user indicated by the detected electroencephalogram signal is less than a predetermined level, the control device controls display so that the image is displayed to the user, the image being in accordance with a field of vision guide.

9. The image display device of claim 1, wherein, when a level of familiarity of the user with respect to the game indicated by the detected electroencephalogram signal is less than a predetermined level, the control device controls display of the image at every interval of a plurality of predetermined fixed intervals and at least one other image different than the image in a period between consecutive ones of the predetermined fixed intervals.

10. An image display method comprising:
estimating, by a control device, a user state based on a detected electroencephalogram signal of a user who is playing a game, and controlling, by the control device, display of an image to the user for providing training for the game based on the user state.

11. A non-transitory recording medium recorded with a program executable by a computer, the program comprising:
estimating a user state based on a detected electroencephalogram signal of a user who is playing a game, and controlling display of an image to the user for providing training for the game based on the user state.

12. An information processing apparatus comprising:
a control device to:
estimate a user state based on a detected electroencephalogram signal of a user who is playing a game, in which the detected electroencephalogram signal is provided from an external device over a communication network, and
control providing, over the communication network, of a display signal to control display of an image to the user for providing training for the game based on the user state.
